(19) United States
(12) Patent Application Publication
(10) Pub. No.: US 2026/0268823 A1
(43) Pub. Date: Sep. 10, 2026

(54) DISPLAY SUBSTRATE AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN); BEIJING BOE TECHNOLOGY DEVELOPMENT CO., LTD., Beijing (CN)

(72) Inventors: Yongxian XIE, Beijing (CN); Xiaoye MA, Beijing (CN); Yongcan WANG, Beijing (CN); Ran ZHANG, Beijing (CN); Tengfei DING, Beijing (CN); Shijun WANG, Beijing (CN); Zhangtao WANG, Beijing (CN)

(73) Assignees: HEFEI XINSHENG OPTOELECTRONICS TECHNOLOGY CO., LTD., Hefei, Anhui (CN); BOE TECHNOLOGY GROUP CO., LTD., Beijing (CN); BEIJING BOE TECHNOLOGY DEVELOPMENT CO., LTD., Beijing (CN)

(21) Appl. No.: 18/993,481

(22) PCT Filed: Sep. 1, 2023
(86) PCT No.: PCT/CN2023/116567

§ 371 Date: Jan. 10, 2025

(51) Int. Cl. G09G 3/20

(52) U.S. Cl. CPC G09G 3/20; G09G 2300/0408; G09G 2300/0426; G09G 2310/08

(57) ABSTRACT

A driving circuit includes a driving control signal generation circuit and a multi-channel output circuit; the multi-channel output circuit includes N stages of output sub-circuits; N is an integer greater than 1; an nth output sub-circuit is electrically connected to the driving control signal output terminal, a control voltage line, an nth control node, an nth output clock signal line and an nth driving signal output terminal respectively, the nth output sub-circuit is configured to control a potential of the nth control node according to the driving control signal under the control of a control voltage provided by the control voltage line, and to control the nth output clock signal line to provide the nth output clock signal to the nth driving signal output terminal under the control of the potential of the nth control node; n is a positive integer less than or equal to N.

### TECHNICAL FIELD

The present disclosure relates to the field of display technology, in particular to a display substrate and a display device.

### BACKGROUND

The related Touch and Display Driver Integration (TDDI) products have a large number of source drivers (S-ICs), and the price of S-ICs is high, resulting in a high cost of current TDDI products. To address this problem, a pixel structure design including three gate electrodes for TDDI display products can be used. In this pixel structure, the pixel electrode is horizontally arranged, the number of gate lines is three times that of normal display products, and the number of data lines is one-third of that of normal display products, which greatly reduces the number of data lines used while ensuring that the resolution of the display product remains unchanged. At the same time, due to the increase in the number of gate lines, the use of a row of GOA (Gate On Array, a gate driving circuit set on an array substrate) architecture driving a row of pixels will increase the left and right borders of the display product.

### SUMMARY

In one aspect, the present disclosure provides in some embodiments a driving circuit, including a driving control signal generation circuit and a multi-channel output circuit; wherein the multi-channel output circuit includes N stages of output sub-circuits; N is an integer greater than 1; the driving control signal generation circuit is configured to generate a driving control signal, and the driving control signal is output through a driving control signal output terminal; an nth output sub-circuit is electrically connected to the driving control signal output terminal, a control voltage line, an nth control node, an nth output clock signal line and an nth driving signal output terminal respectively, the nth output sub-circuit is configured to control a potential of the nth control node according to the driving control signal under the control of a control voltage provided by the control voltage line, and to control the nth output clock signal line to provide the nth output clock signal to the nth driving signal output terminal under the control of the potential of the nth control node; n is a positive integer less than or equal to N.

Optionally, the nth output sub-circuit includes an nth control unit and an nth output unit; the nth control unit is electrically connected to the driving control signal output terminal, the control voltage line and the nth control node respectively, and is configured to control the potential of the nth control node according to the driving control signal under the control of the control voltage; the nth output unit is electrically connected to the nth control node, the nth output clock signal line and the nth driving signal output terminal, respectively, and is configured to control the nth output clock signal line to provide the nth output clock signal to the nth driving signal output terminal under the control of the potential of the nth control node.

Optionally, the nth control unit includes an nth first control transistor; a gate electrode of the nth first control transistor is electrically connected to the control voltage line, a first electrode of the nth first control transistor is electrically connected to the driving control signal output terminal, and a second electrode of the nth first control transistor is electrically connected to the nth control node; or, the control voltage line includes a first control voltage line and a second control voltage line, and the nth control unit includes an nth first control transistor and an nth second control transistor; a gate electrode of the nth first control transistor is electrically connected to the first control voltage line, a first electrode of the nth first control transistor is electrically connected to the driving control signal output terminal, and a second electrode of the nth first control transistor is electrically connected to the nth control node; a gate electrode of the nth second control transistor is electrically connected to the second control voltage line, a first electrode of the nth second control transistor is electrically connected to the driving control signal output terminal, and a second electrode of the nth second control transistor is electrically connected to the nth control node.

Optionally, the nth output unit comprises an nth output transistor; a gate electrode of the nth output transistor is electrically connected to the nth control node, a first electrode of the nth output transistor is electrically connected to the nth output clock signal line, and a second electrode of the nth output transistor is electrically connected to the nth driving signal output terminal.

Optionally, the nth output sub-circuit further comprises an nth shutdown reset unit; the nth shutdown reset unit is electrically connected to the first voltage line and the nth driving signal output terminal respectively, and is configured to control the connection or disconnection between the nth driving signal output terminal and the first voltage line under the control of the first voltage signal provided by the first voltage line.

Optionally, the nth shutdown reset unit comprises an nth shutdown reset transistor; a gate electrode and a second electrode of the nth shutdown reset transistor are both electrically connected to the first voltage line, and a first electrode of the nth shutdown reset transistor is electrically connected to the nth driving signal output terminal.

Optionally, the nth output sub-circuit further comprises an nth output capacitor; a first terminal of the nth output capacitor is electrically connected to the nth control node, and a second terminal of the nth output capacitor is electrically connected to the nth driving signal output terminal.

Optionally, the nth output sub-circuit further comprises an nth output pull-down unit; the nth output pull-down unit is electrically connected to the pull-down node, the nth driving signal output terminal and the first voltage line respectively, and is configured to control the connection or disconnection between the nth driving signal output terminal and the first voltage line under the control of the potential of the pull-down node.

Optionally, the nth output pull-down unit includes an nth first output pull-down transistor; a gate electrode of the nth first output pull-down transistor is electrically connected to the pull-down node, a first electrode of the nth first output pull-down transistor is electrically connected to the nth driving signal output terminal, and a second electrode of the nth first output pull-down transistor is electrically connected to the first voltage line; or, the pull-down node includes a first pull-down node and a second pull-down node; the nth output pull-down unit includes an nth first output pull-down transistor and an nth second output pull-down transistor; a gate electrode of the nth first output pull-down transistor is electrically connected to the first pull-down node, a first electrode of the nth first output pull-down transistor is electrically connected to the nth driving signal output terminal, and a second electrode of the nth first output pull-down transistor is electrically connected to the first voltage line; a gate electrode of the nth second output pull-down transistor is electrically connected to the second pull-down node, a first electrode of the nth second output pull-down transistor is electrically connected to the nth driving signal output terminal, and a second electrode of the nth second output pull-down transistor is electrically connected to the first voltage line.

Optionally, the pull-down node includes a first pull-down node and a second pull-down node; the driving control signal generation circuit includes a pull-up node control circuit, a first pull-down node control circuit, a second pull-down node control circuit and a driving control output circuit; the pull-up node control circuit is configured to control a potential of the pull-up node; the first pull-down node control circuit is configured to control a potential of the first pull-down node under the control of the potential of the pull-up node; the second pull-down node control circuit is configured to control a potential of the second pull-down node under the control of the potential of the pull-up node; the driving control output circuit is electrically connected to the pull-up node, the first pull-down node, the second pull-down node, the driving control signal output terminal, the driving control clock signal line and the first voltage line, respectively, and is configured to control the driving control clock signal line to be electrically connected to the driving control signal output terminal under the control of the potential of the pull-up node, control the driving control signal output terminal to be connected to the first voltage line under the control of the potential of the first pull-down node, and control the driving control signal output terminal to be connected to the first voltage line under the control of the potential of the second pull-down node.

Optionally, the driving control signal generation circuit further comprises a carry output circuit; the carry output circuit is electrically connected to the pull-up node, the first pull-down node, the second pull-down node, the carry output terminal, the driving control clock signal line and the second voltage line, respectively, and is configured to control the driving control clock signal line to be electrically connected to the carry output terminal under the control of the potential of the pull-up node, control the carry output terminal to be connected to the second voltage line under the control of the potential of the first pull-down node, and control the carry output terminal to be connected to the second voltage line under the control of the potential of the second pull-down node.

Optionally, the pull-up node control circuit is electrically connected to an input terminal, a frame reset line, the first pull-down node, the second pull-down node, the first reset terminal, the pull-up node, and the second voltage line, respectively, and is configured to control the potential of the pull-up node under the control of the input signal provided by the input terminal, and control the connection between the pull-up node and the second voltage line under the control of the frame reset signal provided by the frame reset line, control the connection between the pull-up node and the second voltage line under the control of the potential of the first pull-down node, control the connection between the pull-up node and the second voltage line under the control of the potential of the second pull-down node, and control the connection between the pull-up node and the second voltage line under the control of the first reset signal provided by the first reset terminal; the first pull-down node control circuit is electrically connected to the first control voltage line, the first pull-down node, the pull-up node and the second voltage line respectively, and is configured to control the potential of the first pull-down node under the control of the first control voltage provided by the first control voltage line and the potential of the pull-up node; the second pull-down node control circuit is electrically connected to the second control voltage line, the second pull-down node, the pull-up node and the second voltage line respectively, and is configured to control the potential of the second pull-down node under the control of the second control voltage provided by the second control voltage line and the potential of the pull-up node; the driving control output circuit is also electrically connected to a second reset terminal, and is configured to control the connection between the driving control signal output terminal and the first voltage line under the control of a second reset signal provided by the second reset terminal.

Optionally, the pull-up node control circuit includes a first transistor, a second transistor, a third transistor, a fourth transistor and a fifth transistor; a gate electrode of the first transistor and a first electrode of the first transistor are electrically connected to the input terminal, and a second electrode of the first transistor is electrically connected to the pull-up node; a gate electrode of the second transistor is electrically connected to the first reset terminal, a first electrode of the second transistor is electrically connected to the pull-up node, and a second electrode of the second transistor is electrically connected to the second voltage line; a gate electrode of the third transistor is electrically connected to the frame reset line, a first electrode of the third transistor is electrically connected to the pull-up node, and a second electrode of the third transistor is electrically connected to the second voltage line; a gate electrode of the fourth transistor is electrically connected to the first pull-down node, a first electrode of the fourth transistor is electrically connected to the pull-up node, and a second electrode of the fourth transistor is electrically connected to the second voltage line; a gate electrode of the fifth transistor is electrically connected to the second pull-down node, a first electrode of the fifth transistor is electrically connected to the pull-up node, and a second electrode of the fifth transistor is electrically connected to the second voltage line; the first pull-down node control circuit includes a sixth transistor and a seventh transistor; a gate electrode of the sixth transistor and a first electrode of the sixth transistor are electrically connected to the first control voltage line, and a second electrode of the sixth transistor is electrically connected to the first pull-down node; a gate electrode of the seventh transistor is electrically connected to the pull-up node, a first electrode of the seventh transistor is electrically connected to the first pull-down node, and a second electrode of the seventh transistor is electrically connected to the second voltage line; the second pull-down node control circuit includes an eighth transistor and a ninth transistor; a gate electrode of the eighth transistor and a first electrode of the eighth transistor are electrically connected to the second control voltage line, and a second electrode of the eighth transistor is electrically connected to the second pull-down node; a gate electrode of the ninth transistor is electrically connected to the pull-up node, a first electrode of the ninth transistor is electrically connected to the second pull-down node, and a second electrode of the ninth transistor is electrically connected to the second voltage line.

Optionally, the first pull-down node control circuit further includes a tenth transistor, and the second pull-down node control circuit further includes an eleventh transistor; a gate electrode of the tenth transistor is electrically connected to the input terminal, a first electrode of the tenth transistor is electrically connected to the first pull-down node, and a second electrode of the tenth transistor is electrically connected to the second voltage line; a gate electrode of the eleventh transistor is electrically connected to the input terminal, a first electrode of the eleventh transistor is electrically connected to the second pull-down node, and a second electrode of the eleventh transistor is electrically connected to the second voltage line; the carry output circuit includes a twelfth transistor, a thirteenth transistor and a fourteenth transistor; a gate electrode of the twelfth transistor is electrically connected to the pull-up node, a first electrode of the twelfth transistor is electrically connected to the driving control clock signal line, and a second electrode of the twelfth transistor is electrically connected to the carry output terminal; a gate electrode of the thirteenth transistor is electrically connected to the first pull-down node, a first electrode of the thirteenth transistor is electrically connected to the carry output terminal, and a second electrode of the thirteenth transistor is electrically connected to the second voltage line; a gate electrode of the fourteenth transistor is electrically connected to the second pull-down node, a first electrode of the fourteenth transistor is electrically connected to the carry output terminal, and a second electrode of the fourteenth transistor is electrically connected to the second voltage line; the driving control output circuit includes a fifteenth transistor, a sixteenth transistor, a seventeenth transistor, an eighteenth transistor and a first capacitor; a gate electrode of the fifteenth transistor is electrically connected to the pull-up node, a first electrode of the fifteenth transistor is electrically connected to the driving control clock signal line, and a second electrode of the fifteenth transistor is electrically connected to the driving control signal output terminal; a gate electrode of the sixteenth transistor is electrically connected to the first pull-down node, a first electrode of the sixteenth transistor is electrically connected to the driving control signal output terminal, and a second electrode of the sixteenth transistor is electrically connected to the first voltage line; a gate electrode of the seventeenth transistor is electrically connected to the second pull-down node, a first electrode of the seventeenth transistor is electrically connected to the driving control signal output terminal, and a second electrode of the seventeenth transistor is electrically connected to the first voltage line; a gate electrode of the eighteenth transistor is electrically connected to the second reset terminal, a first electrode of the eighteenth transistor is electrically connected to the driving control signal output terminal, and a second electrode of the eighteenth transistor is electrically connected to the first voltage line; a first electrode plate of the first capacitor is electrically connected to the pull-up node, and a second electrode plate of the first capacitor is electrically connected to the driving control signal output terminal.

In a second aspect, an embodiment of the present disclosure provides a display substrate, including a base substrate and a plurality of driving circuits arranged on the base substrate.

Optionally, the display substrate comprises a peripheral area and a display area; the driving circuit includes the driving control signal generation circuit and the multi-channel output circuit; the multi-channel output circuit and the driving control signal generation circuit are arranged in the peripheral area; the multi-channel output circuit is arranged on a side of the driving control signal generation circuit close to the display area.

Optionally, the multi-channel output circuit includes N output sub-circuits and N output clock signal lines; N is an integer greater than 1; the output clock signal line is arranged on a side of the output sub-circuit close to the display area, and the output clock signal line extends along a first direction. Optionally, the nth output sub-circuit includes an nth control unit and an nth output unit; n is a positive integer less than or equal to N; the nth control unit is arranged on a side of the nth output unit away from the display area.

Optionally, an active pattern of a transistor included in the nth control unit includes at least one active portion independent of each other, and an active pattern of a transistor included in the nth output unit includes at least one active portion independent of each other.

Optionally, the nth output sub-circuit includes an nth shutdown reset unit, an nth output capacitor and an nth output pull-down unit; the nth output pull-down unit is arranged between the nth shutdown reset unit and the nth output capacitor; the nth output capacitor is arranged between the nth output unit and the nth output pull-down unit; output capacitors respectively included in the N output sub-circuits are arranged along the first direction; active layer patterns of transistors in the shutdown reset units included in the N output sub-circuits are arranged along the first direction; active layer patterns of transistors in output pull-down units included in the N output sub-circuits are arranged along the first direction.

Optionally, the display substrate further includes a driving control clock signal line, a frame reset line, a first voltage line, a second voltage line, a first control voltage line, and a second control voltage line; wherein the driving control clock signal line, the frame reset line, the first voltage line, the second voltage line, the first control voltage line and the second control voltage line are arranged on a side of the driving control signal generation circuit away from the display area.

Optionally, a channel width-to-length ratio of a transistor included in the nth control unit is greater than or equal to 40 and less than or equal to 80; a channel width-to-length ratio of a transistor included in the nth output unit is greater than or equal to 100 and less than or equal to 200.

Optionally, the display substrate further includes a plurality of rows of gate lines, a plurality of columns of data lines and a plurality of pixels arranged in the display area; wherein the pixel includes M sub-pixels with different colors; M is an integer greater than or equal to 3; the sub-pixel comprises a switch transistor and a pixel electrode; the pixel electrode comprises at least one pixel electrode portion electrically connected to each other; the pixel electrode portion extends along a second direction, the gate line extends along a third direction, and the data line extends along the first direction; the second direction is substantially the same as the third direction, the first direction intersects the second direction, and the first direction intersects the third direction; a row of gate line is arranged between two adjacent rows of sub-pixels, and a column of data line is arranged between two adjacent columns of sub-pixels; a gate electrode of the switch transistor is electrically connected to a corresponding gate line, a first electrode of the switch transistor is electrically connected to the pixel electrode, and a second electrode of the switch transistor is electrically connected to a corresponding data line.

Optionally, the gate line includes a first terminal and a second terminal; the driving circuit is electrically connected to a signal input terminal of the gate line, and is configured to provide a driving signal to the gate line through the signal input terminal; the signal input terminal is the first terminal or the second terminal; the display substrate further comprises a plurality of electrostatic discharge blocks arranged on the base substrate; the electrostatic discharge blocks are conductive blocks; the electrostatic discharge block is electrically connected to a terminal of the gate line other than the signal input terminal.

Optionally, the electrostatic discharge block and the gate line are arranged in a same layer and made of a same material.

Optionally, a length of the electrostatic discharge block along the first direction is greater than a line width of the gate line.

Optionally, a side length of an orthographic projection of the electrostatic discharge block on the base substrate is greater than or equal to 12 μm and less than or equal to 30 μm, and the line width of the gate line is greater than or equal to 3 μm and less than or equal to 4 μm.

Optionally, a channel width-to-length ratio of the switch transistor is greater than or equal to 0.8 and less than or equal to 2, and a channel length of the switch transistor is greater than or equal to 3 μm and less than or equal to 6 μm.

Optionally, the display substrate further includes a plurality of columns of touch signal lines; wherein the touch signal line is arranged between two columns of sub-pixels, and the touch signal line is arranged adjacent to the data line; the display substrate further comprises a common electrode, and the common electrode comprises a plurality of common electrode blocks which are independent of each other; the pixel electrode is arranged on a side of the common electrode away from the base substrate; the touch signal line is electrically connected to the common electrode block through a first via hole.

Optionally, the touch signal line and the data line are arranged in a same layer; the display substrate further comprises a conductive pattern arranged in a same layer as the pixel electrode; the conductive pattern is electrically connected to the touch signal line and the common electrode block respectively through the first via hole, so that the touch signal line is electrically connected to the common electrode block; the pixel electrode includes a plurality of pixel electrode portions; at least one pixel electrode portion included in the pixel electrode and the conductive pattern are arranged along a fourth direction; a length of at least one pixel electrode portion along the fourth direction is smaller than a length of a pixel electrode portion of the pixel electrode other than the at least one pixel electrode portion along the fourth direction.

Optionally, the first via hole includes a first via hole portion and a second via hole portion, and the touch signal line, the common electrode block and the conductive pattern are arranged in sequence along a direction away from the base substrate; the conductive pattern is electrically connected to the touch signal line through the first via hole portion, and the conductive pattern is electrically connected to the common electrode block through the second via hole portion.

Optionally, the touch signal line is formed in a source-drain metal layer, the common electrode block is formed in a first conductive layer, and the pixel electrode is formed in a second conductive layer; the source-drain metal layer, the first conductive layer and the second conductive layer are arranged in sequence along a side away from the display substrate.

Optionally, the display substrate further includes a virtual sub-pixel; wherein the virtual sub-pixel is arranged in the peripheral area, and the virtual sub-pixel is arranged closely adjacent to the display area; a length of the virtual sub-pixel along the fourth direction is smaller than a length of the sub-pixel along the fourth direction.

In a third aspect, an embodiment of the present disclosure provides a display device including the display substrate.

### BRIEF DESCRIPTION OF THE DRAWINGS

FIG. 1 is a structural diagram of a driving circuit according to at least one embodiment of the present disclosure;

FIG. 2 is a structural diagram of a driving circuit according to at least one embodiment of the present disclosure;

FIG. 3 is a structural diagram of a driving circuit according to at least one embodiment of the present disclosure;

FIG. 4 is a structural diagram of a driving circuit according to at least one embodiment of the present disclosure;

FIG. 5 is a structural diagram of a driving circuit according to at least one embodiment of the present disclosure;

FIG. 6 is a circuit diagram of a driving circuit according to at least one embodiment of the present disclosure;

FIG. 7 is a working timing diagram of the driving circuit shown in FIG. 6 of the present disclosure when in operation;

FIG. 8 is a timing diagram of the driving control signal provided by G01, the potential of NC1, and the first driving signal outputted by GO1 when the driving circuit shown in FIG. 6 is working;

FIG. 9 is a circuit diagram of a driving circuit according to at least one embodiment of the present disclosure;

FIG. 10 is a timing diagram of the driving circuit according to at least one embodiment of the present disclosure shown in FIG. 9;

FIGS. 11A and 11B are layout diagrams of the driving circuit shown in FIG. 9;

FIG. 12 is a layout diagram of the gate metal layer in FIG. 11A;

FIG. 13A is a layout diagram of the semiconductor layer in FIG. 11A;

FIG. 13B is a layout diagram of the source-drain metal layer in FIG. 11A;

FIG. 14 is a layout diagram of some sub-pixels in the display area of the display panel;

FIG. 15 is a layout diagram of the gate metal layer in FIG. 14;

FIG. 16 is a layout diagram of the semiconductor layer in FIG. 14;

FIG. 17 is a layout diagram of the source-drain metal layer in FIG. 14;

FIG. 18 is a layout diagram of the first conductive layer in FIG. 14;

FIG. 19 is a layout diagram of the second conductive layer in FIG. 14;

FIG. 20 is a layout diagram of the connection between a GOA (Gate On Array, a gate driving circuit arranged on an array substrate) region and a display region in at least one embodiment of the present disclosure;

FIG. 21 is a layout diagram of the gate metal layer in FIG. 20;

FIG. 22 is a layout diagram of the semiconductor layer in FIG. 20;

FIG. 23 is a layout diagram of the source-drain metal layer in FIG. 20;

FIG. 24 is a layout diagram of the first conductive layer in FIG. 20;

FIG. 25 is a layout diagram of the second conductive layer in FIG. 20;

FIG. 26 is a layout diagram of a partial area in the display area of the display panel;

FIG. 27 is a layout diagram of the gate metal layer in FIG. 26;

FIG. 28 is a layout diagram of the semiconductor layer in FIG. 26;

FIG. 29 is a layout diagram of the source-drain metal layer in FIG. 26;

FIG. 30 is a layout diagram of the first conductive layer in FIG. 26;

FIG. 31 is a layout diagram of the second conductive layer in FIG. 26;

FIG. 32 is an enlarged schematic diagram of the first via hole in FIG. 26;

FIG. 33 is a cross-sectional view taken along line AA′ in FIG. 32;

FIG. 34 is a waveform diagram of various signals in a driving module in at least one embodiment of the present disclosure;

FIG. 35 is a waveform diagram of various signals in a driving module in at least one embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without making creative efforts fall within the scope of protection of the present disclosure.

As used in the present disclosure, “parallel”, “perpendicular”, and “equal” include the situations described and situations similar to the situations described, and the range of the similar situations is within the acceptable deviation range, wherein the acceptable deviation range is determined by a person of ordinary skill in the art taking into account the measurement and the errors associated with the measurement of a particular quantity (i.e., the limitations of the measurement system). For example, “parallel” includes absolute parallelism and approximate parallelism, wherein the acceptable deviation range of approximate parallelism can be, for example, a deviation within 5°; “perpendicular” includes absolute perpendicularity and approximate perpendicularity, wherein the acceptable deviation range of approximate perpendicularity can also be, for example, a deviation within 5°. “Equal” includes absolute equality and approximate equality, wherein the acceptable deviation range of approximate equality can be, for example, the difference between the two equalities is less than or equal to 10% of either one of them.

It will be understood that when a layer or an element is referred to as being on another layer or substrate, it can be directly on the other layer or substrate, or intervening layers may be present between the layer or element and the other layer or substrate.

The present disclosure describes exemplary embodiments with reference to cross-sectional views and/or plan views that are idealized exemplary drawings. In the drawings, the thickness of the layers and the area of the regions are exaggerated for clarity. Therefore, variations in the shapes relative to the drawings due to, for example, manufacturing techniques and/or tolerances are conceivable. Therefore, the exemplary embodiments should not be interpreted as being limited to the shapes of the regions shown herein, but include shape deviations due to, for example, manufacturing. For example, an etched region shown as a rectangle will typically have curved features. Therefore, the regions shown in the drawings are schematic in nature, and their shapes are not intended to illustrate the actual shapes of the regions of the device, and are not intended to limit the scope of the exemplary embodiments.

In the present disclosure, circles, triangles, rectangles, trapezoids, pentagons or hexagons are not in a strict sense, but may be approximate circles, triangles, rectangles, trapezoids, pentagons or hexagons, etc. There may be some small deformations caused by tolerances, and there may be chamfers, arc edges and deformations.

The present disclosure may be thin film transistors or field effect transistors or other devices with the same characteristics. In the embodiments of the present disclosure, in order to distinguish the two electrodes of the transistor except the gate electrode, one of the electrodes is called the first electrode and the other is called the second electrode.

In actual operation, when the transistor is a thin film transistor or a field effect transistor, the first electrode may be a drain electrode, and the second electrode may be a source electrode; or, the first electrode may be a source electrode, and the second electrode may be a drain electrode.

The driving circuit in an embodiment of the present disclosure includes a driving control signal generation circuit and a multi-channel output circuit; the multi-channel output circuit includes N stages of output sub-circuits; N is an integer greater than 1;

The driving control signal generation circuit is configured to generate a driving control signal, and the driving control signal is output through a driving control signal output terminal;

an nth output sub-circuit is electrically connected to the driving control signal output terminal, a control voltage line, an nth control node, an nth output clock signal line and an nth driving signal output terminal respectively, the nth output sub-circuit is configured to control a potential of the nth control node according to the driving control signal under the control of a control voltage provided by the control voltage line, and to control the nth output clock signal line to provide the nth output clock signal to the nth driving signal output terminal under the control of the potential of the nth control node; n is a positive integer less than or equal to N.

In the existing TDDI products, the number of S-ICs is large, and the price of S-ICs is high, resulting in a high cost of current TDDI products. In response to this problem, at least one embodiment of the present disclosure adopts a pixel structure design including three gate electrodes for TDDI display product. In this pixel structure, the pixel electrode is horizontally arranged, the number of gate lines is three times that of a normal display product, and the number of data lines is one-third of a normal display product, ensuring that the resolution of the display product remains unchanged, and greatly reducing the number of data lines used. At the same time, due to the increase in the number of gate lines, the use of a row of GOA architectures driving a row of pixels in the gate driving architecture will increase the left and right borders of the display product. Based on this, the present disclosure proposes a multiplexed gate driving architecture. In order to further achieve a narrow border and reduce costs, when the driving circuit described in the embodiment of the present disclosure is working, the driving control signal generation circuit outputs a driving control signal, and the N stages of output sub-circuits respectively output N stages of driving signals under the control of the driving control signal, which can achieve the purpose of one driving circuit driving a plurality of rows of gate lines, effectively reducing the number of transistors used in the driving circuit, and facilitating the realization of a narrow border.

In at least one embodiment of the present disclosure, N is taken as 4 as an example for illustration.

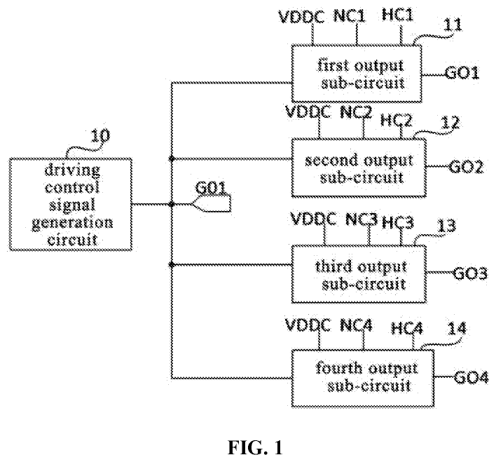

As shown in FIG. 1, the driving circuit according to at least one embodiment of the present disclosure includes a driving control signal generation circuit 10, a first output sub-circuit 11, a second output sub-circuit 12, a third output sub-circuit 13 and a fourth output sub-circuit 14;

The driving control signal generation circuit 10 is configured to generate a driving control signal, and the driving control signal is output through the driving control signal output terminal G01;

The first output sub-circuit 11 is electrically connected to the driving control signal output terminal G01, the control voltage line VDDC, the first control node NC1, the first output clock signal line HC1 and the first driving signal output terminal GO1 respectively. The first output sub-circuit 11 is configured to control the potential of the first control node NC1 according to the driving control signal under the control of the control voltage provided by the control voltage line VDDC, and control the first output clock signal line HC1 to provide a first output clock signal to the first driving signal output terminal GO1 under the control of the potential of the first control node NC1;

The second output sub-circuit 12 is electrically connected to the driving control signal output terminal GO1, the control voltage line VDDC, the second control node NC2, the second output clock signal line HC2 and the second driving signal output terminal GO2 respectively, and the second output sub-circuit 12 is configured to control the potential of the second control node NC2 according to the driving control signal under the control of the control voltage provided by the control voltage line VDDC, and control the second output clock signal line HC2 to provide a second output clock signal to the second driving signal output terminal GO2 under the control of the potential of the second control node NC2;

The third output sub-circuit 13 is electrically connected to the driving control signal output terminal GO1, the control voltage line VDDC, the third control node NC3, the third output clock signal line HC3 and the third driving signal output terminal GO3 respectively. The third output sub-circuit 13 is configured to control the potential of the third control node NC3 according to the driving control signal under the control of the control voltage provided by the control voltage line VDDC, and to control the third output clock signal line HC3 to provide a third output clock signal to the third driving signal output terminal GO3 under the control of the potential of the third control node NC3;

The fourth output sub-circuit 14 is electrically connected to the driving control signal output terminal GO1, the control voltage line VDDC, the fourth control node NC4, the fourth output clock signal line HC4 and the fourth driving signal output terminal GO4, respectively. The fourth output sub-circuit 14 is configured to control the potential of the fourth control node NC4 according to the driving control signal under the control of the control voltage provided by the control voltage line VDDC, and to control the fourth output clock signal line HC4 to provide a fourth output clock signal to the fourth driving signal output terminal GO4 under the control of the potential of the fourth control node NC4.

In at least one embodiment of the present disclosure, the nth output sub-circuit includes an nth control unit and an nth output unit;

The nth control unit is electrically connected to the driving control signal output terminal, the control voltage line and the nth control node respectively, and is configured to control the potential of the nth control node according to the driving control signal under the control of the control voltage;

The nth output unit is electrically connected to the nth control node, the nth output clock signal line and the nth driving signal output terminal, respectively, and is configured to control the nth output clock signal line to provide the nth output clock signal to the nth driving signal output terminal under the control of the potential of the nth control node.

In a specific implementation, the nth output sub-circuit includes an nth control unit and an nth output unit. The nth control unit controls the potential of the nth control node according to a driving control signal under the control of a control voltage. The nth output unit controls to provide the nth output clock signal to the nth driving signal output terminal under the control of the potential of the nth control node.

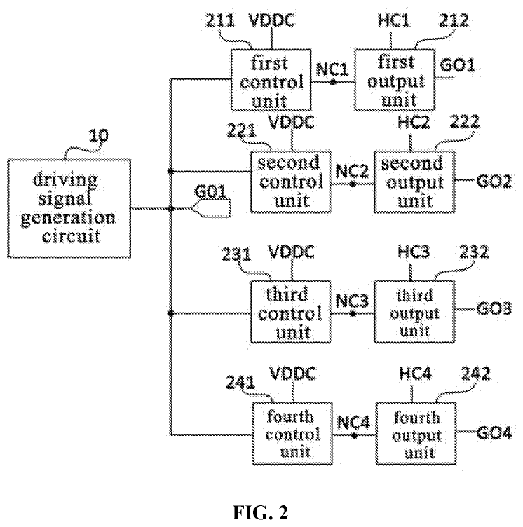

As shown in FIG. 2, based on one embodiment of the driving circuit shown in FIG. 1, the first output sub-circuit includes a first control unit 211 and a first output unit 212;

The first control unit 211 is electrically connected to the driving control signal output terminal G01, the control voltage line VDDC and the first control node NC1 respectively, and is configured to control the potential of the first control node NC1 according to the driving control signal under the control of the control voltage;

The first output unit 212 is electrically connected to the first control node NC1, the first output clock signal line HC1 and the first driving signal output terminal GO1 respectively, and is configured to control the first output clock signal line HC1 to provide the first output clock signal to the first driving signal output terminal GO1 under the control of the potential of the first control node NC1;

The second output sub-circuit includes a second control unit 221 and a second output unit 222;

The second control unit 221 is electrically connected to the driving control signal output terminal G01, the control voltage line VDDC and the second control node NC2 respectively, and is configured to control the potential of the second control node NC2 according to the driving control signal under the control of the control voltage;

The second output unit 222 is electrically connected to the second control node NC2, the second output clock signal line HC2 and the second driving signal output terminal GO2 respectively, and is configured to control the second output clock signal line HC2 to provide the second output clock signal to the second driving signal output terminal GO2 under the control of the potential of the second control node NC2;

The third output sub-circuit includes a third control unit 231 and a third output unit 232;

The third control unit 231 is electrically connected to the driving control signal output terminal G01, the control voltage line VDDC and the third control node NC3 respectively, and is configured to control the potential of the third control node NC3 according to the driving control signal under the control of the control voltage;

The third output unit 232 is electrically connected to the third control node NC3, the third output clock signal line HC3 and the third driving signal output terminal GO3 respectively, and is configured to control the third output clock signal line HC3 to provide a third output clock signal to the third driving signal output terminal GO3 under the control of the potential of the third control node NC3;

The fourth output sub-circuit includes a fourth control unit 241 and a fourth output unit 242;

The fourth control unit 241 is electrically connected to the driving control signal output terminal G01, the control voltage line VDDC and the fourth control node NC4 respectively, and is configured to control the potential of the fourth control node NC4 according to the driving control signal under the control of the control voltage;

The fourth output unit 242 is electrically connected to the fourth control node NC4, the fourth output clock signal line HC4 and the fourth driving signal output terminal GO4, respectively, and is configured to control the fourth output clock signal line HC4 to provide a fourth output clock signal to the fourth driving signal output terminal GO4 under the control of the potential of the fourth control node NC4.

Optionally, the nth control unit includes an nth first control transistor; a gate electrode of the nth first control transistor is electrically connected to the control voltage line, a first electrode of the nth first control transistor is electrically connected to the driving control signal output terminal, and a second electrode of the nth first control transistor is electrically connected to the nth control node; or,

The control voltage line includes a first control voltage line and a second control voltage line, and the nth control unit includes an nth first control transistor and an nth second control transistor; a gate electrode of the nth first control transistor is electrically connected to the first control voltage line, a first electrode of the nth first control transistor is electrically connected to the driving control signal output terminal, and a second electrode of the nth first control transistor is electrically connected to the nth control node; a gate electrode of the nth second control transistor is electrically connected to the second control voltage line, a first electrode of the nth second control transistor is electrically connected to the driving control signal output terminal, and a second electrode of the nth second control transistor is electrically connected to the nth control node.

In a specific implementation, when the nth control unit includes only one control transistor, and the gate electrode of the control transistor is electrically connected to the control voltage line, after the control transistor is used for a long time, the threshold voltage drifts, resulting in the charging of the gate electrode of the output transistor becoming weaker, and the pre-charging time of the first row of pixels in the four rows of pixels controlled by G01 is the shortest, and the pre-charging time increases successively from the first row of pixels to the fourth row of pixels, resulting in differences in the gate voltages of the output transistors in the four output sub-circuits, thereby resulting in differences in the waveforms of the driving signals provided by the four output sub-circuits, the high level of the driving signal provided by the first output sub-circuit is the lowest, and the high level of the driving signal provided by the fourth output sub-circuit is the highest, resulting in differences in the brightness of the circuits of the adjacent four rows of pixels, resulting in horizontal stripes. Based on this, at least one embodiment of the present disclosure uses two control voltage lines and two control transistors, and the two control voltage lines respectively control the two control transistors to work alternately, and the charging difference of different rows can reach 6 mV (the corresponding brightness difference is less than 1 grayscale).

In a specific implementation, the nth control unit may include one control transistor, or the nth control unit may include two control transistors. In at least one embodiment of the present disclosure, the nth control unit includes two control transistors as an example.

In a specific implementation, the control voltage line may include a first control voltage line and a second control voltage line; the first control voltage line is configured to provide a first control voltage, and the second control voltage line is configured to provide a second control voltage, the first control voltage and the second control voltage may be square wave voltages, and the first control voltage may be inversed in phase to the second control voltage.

Optionally, the nth output unit includes an nth output transistor;

A gate electrode of the nth output transistor is electrically connected to the nth control node, a first electrode of the nth output transistor is electrically connected to the nth output clock signal line, and a second electrode of the nth output transistor is electrically connected to the nth driving signal output terminal.

In at least one embodiment of the present disclosure, the nth output sub-circuit further includes an nth shutdown reset unit;

The nth shutdown reset unit is electrically connected to the first voltage line and the nth driving signal output terminal respectively, and is configured to control the connection or disconnection between the nth driving signal output terminal and the first voltage line under the control of the first voltage signal provided by the first voltage line.

In a specific implementation, the nth output sub-circuit may further include an nth shutdown reset unit, which controls the connection or disconnection between the nth driving signal output terminal and the first voltage line under the control of the first voltage signal;

When shutting down, the first voltage line provides a high voltage signal to connect the nth driving signal output terminal to the first voltage line, and the nth driving signal output terminal outputs a high voltage signal to turn on the transistor whose gate electrode in the pixel circuit in the display area is electrically connected to the nth driving signal output terminal, so as to release the residual charge in the pixel and improve the shutdown afterimage phenomenon.

In the existing oxide display products, when shutting down, the control voltages provided by the two control voltage lines are pulled up to a high voltage, the first pull-down node controls the corresponding output pull-down transistor to turn on, the second pull-down node controls the corresponding output pull-down transistor to turn on, and the potential of the voltage signal provided by the low voltage line is also pulled up to a high voltage, at this time, the driving signal output terminal is charged, and the pixel is discharged after the driving signal output terminal is charged with high voltage, thereby achieving the purpose of shutdown discharge. However, the gate-source voltage of the output pull-down transistor is at a high level for a long time, the threshold voltage drift of the output pull-down transistor is large, the drain-source current of the output pull-down transistor is significantly reduced, the charging of the driving signal output terminal is insufficient, and the pixel cannot be fully discharged. In order to improve this problem, at least one embodiment of the present disclosure adds a shutdown reset transistor included in the shutdown reset unit, the gate electrode of the shutdown reset transistor is electrically connected to the low voltage line, and the source electrode and drain electrode are respectively connected to the driving signal output terminal and the low voltage line. For the shutdown reset transistor, its gate-source voltage is OV for a long time, and there is no problem of threshold voltage drift. When shutting down, the low voltage line provides a high voltage signal, the driving signal output terminal outputs a low voltage signal, the shutdown reset transistor is turned on, and the driving signal output terminal is charged with a high voltage, thereby achieving the purpose of shutdown discharge.

Optionally, the nth shutdown reset unit includes an nth shutdown reset transistor;

A gate electrode and a second electrode of the nth shutdown reset transistor are both electrically connected to the first voltage line, and a first electrode of the nth shutdown reset transistor is electrically connected to the nth driving signal output terminal.

Optionally, the nth output sub-circuit further includes an nth output capacitor;

A first terminal of the nth output capacitor is electrically connected to the nth control node, and a second terminal of the nth output capacitor is electrically connected to the nth driving signal output terminal.

In at least one embodiment of the present disclosure, the nth output sub-circuit further includes an nth output pull-down unit;

The nth output pull-down unit is electrically connected to the pull-down node, the nth driving signal output terminal and the first voltage line respectively, and is configured to control the connection or disconnection between the nth driving signal output terminal and the first voltage line under the control of the potential of the pull-down node.

Optionally, the nth output pull-down unit includes an nth first output pull-down transistor; a gate electrode of the nth first output pull-down transistor is electrically connected to the pull-down node, a first electrode of the nth first output pull-down transistor is electrically connected to the nth driving signal output terminal, and a second electrode of the nth first output pull-down transistor is electrically connected to the first voltage line; or,

The pull-down node includes a first pull-down node and a second pull-down node; the nth output pull-down unit includes an nth first output pull-down transistor and an nth second output pull-down transistor; a gate electrode of the nth first output pull-down transistor is electrically connected to the first pull-down node, a first electrode of the nth first output pull-down transistor is electrically connected to the nth driving signal output terminal, and a second electrode of the nth first output pull-down transistor is electrically connected to the first voltage line; a gate electrode of the nth second output pull-down transistor is electrically connected to the second pull-down node, a first electrode of the nth second output pull-down transistor is electrically connected to the nth driving signal output terminal, and a second electrode of the nth second output pull-down transistor is electrically connected to the first voltage line.

In a specific implementation, the pull-down node may include a first pull-down node and a second pull-down node, and the nth output pull-down unit may include two output pull-down transistors. In at least one embodiment of the present disclosure, the nth output pull-down unit includes two output pull-down transistors as an example for description.

Optionally, the first voltage line may be a first low voltage line, but is not limited thereto.

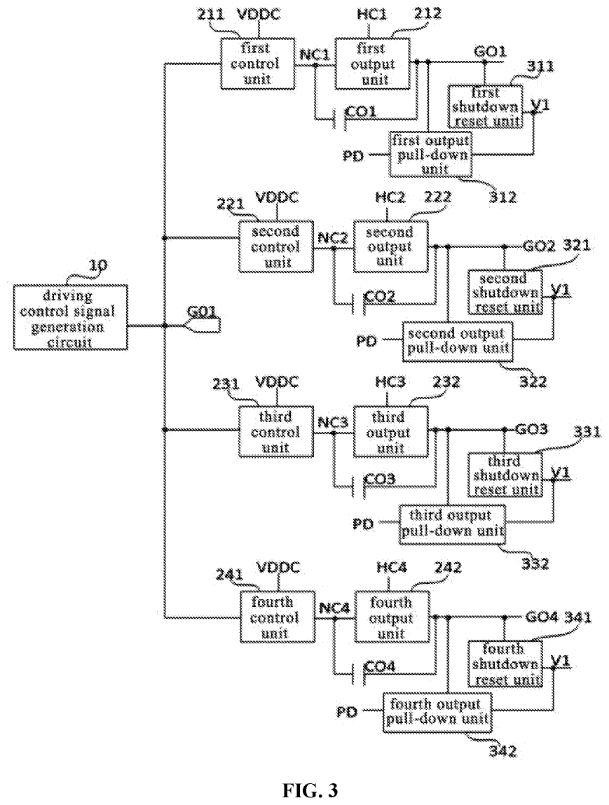

As show in FIG. 3, based on at least one embodiment of the driving circuit shown in FIG. 2,

The first output sub-circuit further includes a first shutdown reset unit 311, a first output capacitor CO1 and a first output pull-down unit 312;

The first shutdown reset unit 311 is electrically connected to the first voltage line V1 and the first driving signal output terminal GO1 respectively, and is configured to control the connection or disconnection between the first driving signal output terminal GO1 and the first voltage line V1 under the control of the first voltage signal provided by the first voltage line V1;

A first terminal of the first output capacitor CO1 is electrically connected to the first control node NC1, and a second terminal of the first output capacitor CO1 is electrically connected to the first driving signal output terminal GO1;

The first output pull-down unit 312 is electrically connected to the pull-down node PD, the first driving signal output terminal GO1 and the first voltage line V1 (VGL) respectively, and is configured to control the connection or disconnection between the first driving signal output terminal GO1 and the first voltage line V1 under the control of the potential of the pull-down node PD;

The second output sub-circuit further includes a second shutdown reset unit 321, a second output capacitor CO2, and a second output pull-down unit 322;

The second shutdown reset unit 321 is electrically connected to the first voltage line V1 and the second driving signal output terminal GO2 respectively, and is configured to control the connection or disconnection between the second driving signal output terminal GO1 and the first voltage line V1 under the control of the first voltage signal provided by the first voltage line V1;

A first terminal of the second output capacitor CO2 is electrically connected to the second control node NC2, and a second terminal of the second output capacitor CO2 is electrically connected to the second driving signal output terminal GO2;

The second output pull-down unit 322 is electrically connected to the pull-down node PD, the second driving signal output terminal GO2 and the first voltage line V1 (VGL) respectively, and is configured to control the connection or disconnection between the second driving signal output terminal GO2 and the first voltage line V1 under the control of the potential of the pull-English down node PD;

The third output sub-circuit further includes a third shutdown reset unit 331, a third output capacitor CO3 and a third output pull-down unit 332;

The third shutdown reset unit 331 is electrically connected to the first voltage line V1 and the third driving signal output terminal GO3 respectively, and is configured to control the connection or disconnection between the third driving signal output terminal GO3 and the first voltage line V1 under the control of the first voltage signal provided by the first voltage line V1;

A first terminal of the third output capacitor CO3 is electrically connected to the third control node NC3, and a second terminal of the third output capacitor CO3 is electrically connected to the third driving signal output terminal GO3;

The third output pull-down unit 332 is electrically connected to the pull-down node PD, the third driving signal output terminal GO3 and the first voltage line V1 respectively, and is configured to control the connection or disconnection between the third driving signal output terminal GO3 and the first voltage line V1 under the control of the potential of the pull-down node PD;

The fourth output sub-circuit further includes a fourth shutdown reset unit 341, a fourth output capacitor CO4 and a fourth output pull-down unit 342;

The fourth shutdown reset unit 341 is electrically connected to the first voltage line V1 and the fourth driving signal output terminal GO4 respectively, and is configured to control the connection or disconnection between the fourth driving signal output terminal GO4 and the first voltage line V1 under the control of the first voltage signal provided by the first voltage line V1;

A first terminal of the fourth output capacitor CO4 is electrically connected to the fourth control node NC4, and a second terminal of the fourth output capacitor CO4 is electrically connected to the fourth driving signal output terminal GO4;

The fourth output pull-down unit 342 is electrically connected to the pull-down node PD, the fourth driving signal output terminal GO4 and the first voltage line V1 respectively, and is configured to control the connection or disconnection between the fourth driving signal output terminal GO4 and the first voltage line V1 under the control of the potential of the pull-down node PD

In a specific implementation, the control voltage line may include two control voltage lines, and the pull-down node may include two pull-down nodes.

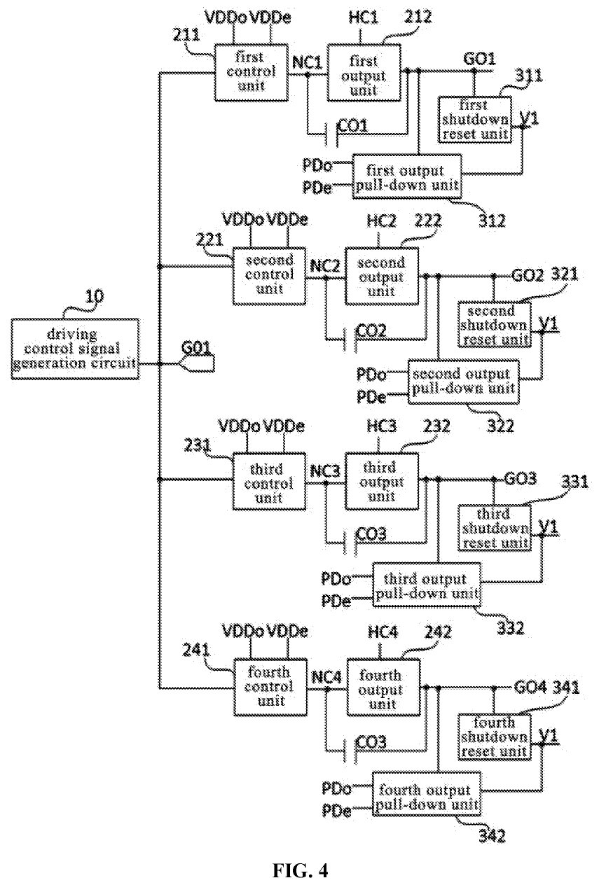

As shown in FIG. 4, based on at least one embodiment of the driving circuit shown in FIG. 3,

The control voltage line includes a first control voltage line VDDo and a second control voltage line VDDe, and the pull-down node includes a first pull-down node PDo and a second pull-down node PDe;

The first control unit 211 is electrically connected to the driving control signal output terminal G01, the first control voltage line VDDo, the second control voltage line VDDe and the first control node NC1 respectively, and is configured to control the potential of the first control node NC1 according to the driving control signal under the control of the first control voltage provided by the first control voltage line VDDo, and to control the potential of the first control node NC1 according to the driving control signal under the control of the second control voltage provided by the second control voltage line VDDe;

The second control unit 221 is electrically connected to the driving control signal output terminal G01, the first control voltage line VDDo, the second control voltage line VDDe and the second control node NC2 respectively, and is configured to control the potential of the second control node NC2 according to the driving control signal under the control of the first control voltage provided by the first control voltage line VDDo, and to control the potential of the second control node NC2 according to the driving control signal under the control of the second control voltage provided by the second control voltage line VDDe;

The third control unit 231 is electrically connected to the driving control signal output terminal G01, the first control voltage line VDDo, the second control voltage line VDDe and the third control node NC3 respectively, and is configured to control the potential of the third control node NC3 according to the driving control signal under the control of the first control voltage provided by the first control voltage line VDDo, and to control the potential of the third control node NC3 according to the driving control signal under the control of the second control voltage provided by the second control voltage line VDDe;

The fourth control unit 241 is electrically connected to the driving control signal output terminal G01, the first control voltage line VDDo, the second control voltage line VDDe and the fourth control node NC4, respectively, and is configured to control the potential of the fourth control node NC4 according to the driving control signal under the control of the first control voltage provided by the first control voltage line VDDo, and to control the potential of the fourth control node NC4 according to the driving control signal under the control of the second control voltage provided by the second control voltage line VDDe;

The first output pull-down unit 312 is electrically connected to the first pull-down node PDo, the second pull-down node PDe, the first driving signal output terminal GO1 and the first voltage line V1, respectively, and is configured to control the connection or disconnection between the first driving signal output terminal GO1 and the first voltage line V1 under the control of the potential of the first pull-down node PDo, and is configured to control the connection or disconnection between the first driving signal output terminal GO1 and the first voltage line V1 under the control of the potential of the second pull-down node PDe;

The second output pull-down unit 322 is electrically connected to the first pull-down node PDo, the second pull-down node PDe, the second driving signal output terminal GO2 and the first voltage line V1, respectively, and is configured to control the connection or disconnection between the second driving signal output terminal GO2 and the first voltage line V1 under the control of the potential of the first pull-down node PDo, and is configured to control the connection or disconnection between the second driving signal output terminal GO2 and the first voltage line V1 under the control of the potential of the second pull-down node PDe;

The third output pull-down unit 332 is electrically connected to the first pull-down node PDo, the second pull-down node PDe, the third driving signal output terminal GO3 and the first voltage line V1, respectively, and is configured to control the connection or disconnection between the third driving signal output terminal GO3 and the first voltage line V1 under the control of the potential of the first pull-down node PDo, and is configured to control the connection or disconnection between the third driving signal output terminal GO3 and the first voltage line V1 under the control of the potential of the second pull-down node PDe;

The fourth output pull-down unit 342 is electrically connected to the first pull-down node PDo, the second pull-down node PDe, the fourth driving signal output terminal GO4 and the first voltage line V1, respectively, and is configured to control the connection or disconnection between the fourth driving signal output terminal GO4 and the first voltage line V1 under the control of the potential of the first pull-down node PDo, and is configured to control the connection or disconnection between the fourth driving signal output terminal GO4 and the first voltage line V1 under the control of the potential of the second pull-down node PDe.

In at least one embodiment of the present disclosure, the pull-down node includes a first pull-down node and a second pull-down node; the driving control signal generation circuit includes a pull-up node control circuit, a first pull-down node control circuit, a second pull-down node control circuit and a driving control output circuit;

The pull-up node control circuit is configured to control a potential of the pull-up node;

The first pull-down node control circuit is configured to control the potential of the first pull-down node under the control of the potential of the pull-up node;

The second pull-down node control circuit is configured to control the potential of the second pull-down node under the control of the potential of the pull-up node;

The driving control output circuit is electrically connected to the pull-up node, the first pull-down node, the second pull-down node, the driving control signal output terminal, the driving control clock signal line and the first voltage line, respectively, and is configured to control the driving control clock signal line to be electrically connected to the driving control signal output terminal under the control of the potential of the pull-up node, control the driving control signal output terminal to be connected to the first voltage line under the control of the potential of the first pull-down node, and control the driving control signal output terminal to be connected to the first voltage line under the control of the potential of the second pull-down node.

In a specific implementation, the driving control clock signal line is configured to provide a driving control clock signal.

In a specific implementation, the driving control signal generation circuit may include a pull-up node control circuit, a first pull-down node control circuit, a second pull-down node control circuit and a driving control output circuit, the pull-up node control circuit controls the potential of the pull-up node, the first pull-down node control circuit controls the potential of the first pull-down node, the second pull-down node control circuit controls the potential of the second pull-down node, and the driving control output circuit controls the driving control signal output terminal to provide a corresponding driving control signal under the control of the potential of the pull-up node, the potential of the first pull-down node and the potential of the second pull-down node.

In at least one embodiment of the present disclosure, the driving control signal generation circuit further includes a carry output circuit;

The carry output circuit is electrically connected to the pull-up node, the first pull-down node, the second pull-down node, the carry output terminal, the driving control clock signal line and the second voltage line, respectively, and is configured to control the driving control clock signal line to be electrically connected to the carry output terminal under the control of the potential of the pull-up node, control the carry output terminal to be connected to the second voltage line under the control of the potential of the first pull-down node, and control the carry output terminal to be connected to the second voltage line under the control of the potential of the second pull-down node.

In a specific implementation, the driving control signal generation circuit may further include a carry output circuit, which controls the carry output terminal to provide a corresponding carry signal under the control of the potential of the pull-up node, the potential of the first pull-down node and the potential of the second pull-down node, and the carry signal may be used for cascading.

In at least one embodiment of the present disclosure, the pull-up node control circuit is electrically connected to an input terminal, a frame reset line, the first pull-down node, the second pull-down node, the first reset terminal, the pull-up node, and the second voltage line, respectively, and is configured to control the potential of the pull-up node under the control of the input signal provided by the input terminal, and control the connection between the pull-up node and the second voltage line under the control of the frame reset signal provided by the frame reset line, control the connection between the pull-up node and the second voltage line under the control of the potential of the first pull-down node, control the connection between the pull-up node and the second voltage line under the control of the potential of the second pull-down node, and control the connection between the pull-up node and the second voltage line under the control of the first reset signal provided by the first reset terminal;

The first pull-down node control circuit is electrically connected to the first control voltage line, the first pull-down node, the pull-up node and the second voltage line respectively, and is configured to control the potential of the first pull-down node under the control of the first control voltage provided by the first control voltage line and the potential of the pull-up node;

The second pull-down node control circuit is electrically connected to the second control voltage line, the second pull-down node, the pull-up node and the second voltage line respectively, and is configured to control the potential of the second pull-down node under the control of the second control voltage provided by the second control voltage line and the potential of the pull-up node;

The driving control output circuit is also electrically connected to a second reset terminal, and is configured to control the connection between the driving control signal output terminal and the first voltage line under the control of a second reset signal provided by the second reset terminal.

Optionally, the second voltage line may be the first low voltage line, but is not limited thereto.

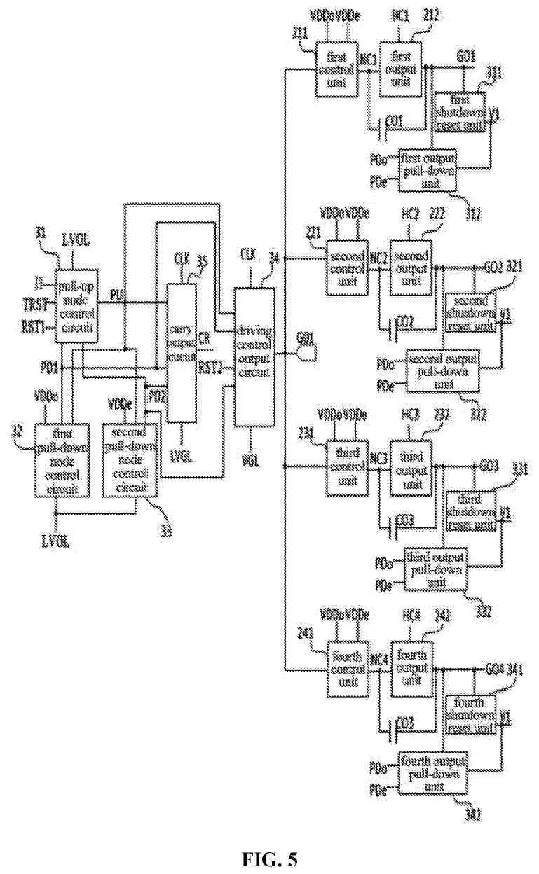

As shown in FIG. 5, based on at least one embodiment of the driving circuit shown in FIG. 4,

The driving control signal generation circuit may include a pull-up node control circuit 31, a first pull-down node control circuit 32, a second pull-down node control circuit 33, a driving control output circuit 34 and a carry output circuit 35;

The pull-up node control circuit 31 is electrically connected to the input terminal I1, the frame reset line TRST, the first pull-down node PD1, the second pull-down node PD2, the first reset terminal RST1, the pull-up node PU and the second low voltage line LVGL, respectively, and is configured to control the potential of the pull-up node PU under the control of the input signal provided by the input terminal I1, and control the connection between the pull-up node PU and the second low voltage line LVGL under the control of the frame reset signal provided by the frame reset line TRST, control the connection between the pull-up node PU and the second low voltage line LVGL under the control of the potential of the first pull-down node PD1, control the connection between the pull-up node PU and the second low voltage line LVGL under the control of the potential of the second pull-down node PD2, and control the connection between the pull-up node PU and the second low voltage line LVGL under the control of the first reset signal provided by the first reset terminal RST1;

The first pull-down node control circuit 32 is electrically connected to the first control voltage line VDDo, the first pull-down node PD1, the pull-up node PU and the second low voltage line LVGL, respectively, and is configured to control the potential of the first pull-down node PD1 under the control of the first control voltage provided by the first control voltage line VDDo and the potential of the pull-up node PU;

The second pull-down node control circuit 33 is electrically connected to the second control voltage line VDDe, the second pull-down node PD2, the pull-up node PU and the second low voltage line LVGL, respectively, and is configured to control the potential of the second pull-down node PD2 under the control of the second control voltage provided by the second control voltage line VDDe and the potential of the pull-up node PU;

The driving control output circuit 34 is electrically connected to the pull-up node PU, the first pull-down node PD1, the second pull-down node PD2, the driving control signal output terminal G01, the driving control clock signal line CLK and the first low voltage line VGL, respectively, and is configured to control the driving control clock signal line CLK to be electrically connected to the driving control signal output terminal G01 under the control of the potential of the pull-up node PU, control the driving control signal output terminal G01 to be connected to the first low voltage line VGL under the control of the potential of the first pull-down node PD1, and control the driving control signal output terminal G01 to be connected to the first low voltage line VGL under the control of the potential of the second pull-down node PD2;

The driving control output circuit 34 is also electrically connected to the second reset terminal RST2, and is configured to control the driving control signal output terminal G01 to be connected to the first low voltage line VGL under the control of the second reset signal provided by the second reset terminal RST2;

The carry output circuit 35 is electrically connected to the pull-up node PU, the first pull-down node PD1, the second pull-down node PD2, the carry output terminal CR, the driving control clock signal line CLK and the second low voltage line LVGL, respectively, and is configured to control the driving control clock signal line CLK to be electrically connected to the carry output terminal CR under the control of the potential of the pull-up node PU, control the carry output terminal CR to be connected to the second low voltage line under the control of the potential of the first pull-down node PD1, and control the carry output terminal CR to be connected to the second low voltage line LVGL under the control of the potential of the second pull-down node PD3.

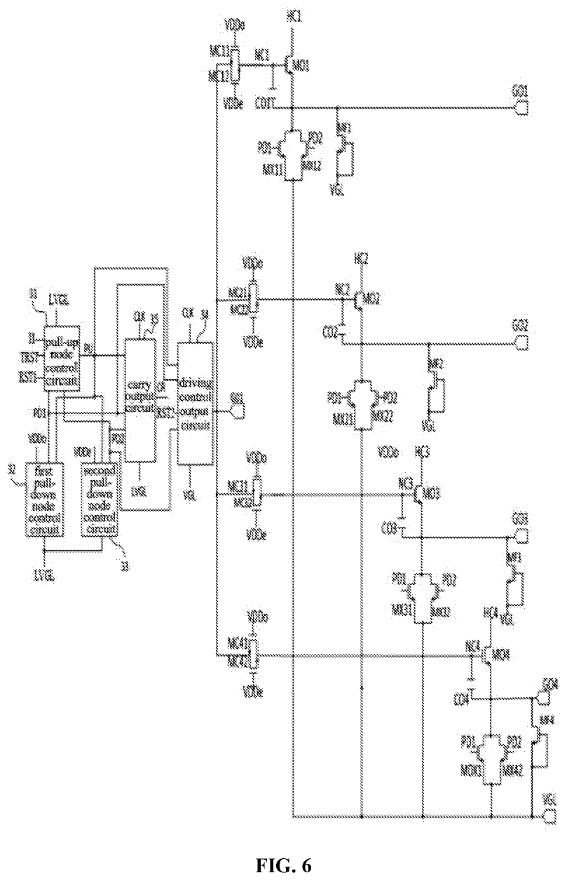

As shown in FIG. 6, in one embodiment of the driving circuit shown in FIG. 5, the first output sub-circuit may include a first first control transistor MC11, a first second control transistor MC12, a first output transistor MO1, a first shutdown reset transistor MF1, a first output capacitor CO1, a first first output pull-down transistor MX11, and a first second output pull-down transistor MX12;

The gate electrode of MC11 is electrically connected to the first control voltage line VDDo, the source electrode of MC11 is electrically connected to the driving control signal output terminal G01, and the drain electrode of MC11 is electrically connected to the first control node NC1;

The gate electrode of MC12 is electrically connected to the second control voltage line VDDe, the source electrode of MC12 is electrically connected to the driving control signal output terminal G01, and the drain electrode of MC12 is electrically connected to the first control node NC1;

The gate electrode of MO1 is electrically connected to the first control node NC1, the source electrode of MO1 is electrically connected to the first output clock signal line HC1, and the drain electrode of MO1 is electrically connected to the nth driving signal output terminal GO1;

The gate electrode of MF1 and the drain electrode of MF1 are electrically connected to the first low voltage line VGL, and the source electrode of MF1 is electrically connected to the first driving signal output terminal GO1;

A first terminal of the first output capacitor CO1 is electrically connected to the first control node NC1, and a second terminal of the first output capacitor CO1 is electrically connected to the first driving signal output terminal GO1;

The gate electrode of MX11 is electrically connected to the first pull-down node PD1, the source electrode of MX11 is electrically connected to the first driving signal output terminal GO1, and the drain electrode of MX11 is electrically connected to the first low voltage line VGL;

The gate electrode of MX12 is electrically connected to the second pull-down node PD2, the source electrode of MX12 is electrically connected to the first driving signal output terminal GO1, and the drain electrode of MX12 is electrically connected to the first low voltage line VGL;

The second output sub-circuit may include a second first control transistor MC21, a second second control transistor MC22, a second output transistor MO2, a second shutdown reset transistor MF2, a second output capacitor CO2, a second first output pull-down transistor MX21, and a second second output pull-down transistor MX22;

The gate electrode of MC21 is electrically connected to the first control voltage line VDDo, the source electrode of MC21 is electrically connected to the driving control signal output terminal G01, and the drain electrode of MC21 is electrically connected to the second control node NC2;

The gate electrode of MC22 is electrically connected to the second control voltage line VDDe, the source electrode of MC22 is electrically connected to the driving control signal output terminal G01, and the drain electrode of MC22 is electrically connected to the second control node NC2;

The gate electrode of MO2 is electrically connected to the second control node NC2, the source electrode of MO2 is electrically connected to the second output clock signal line HC2, and the drain electrode of MO2 is electrically connected to the second driving signal output terminal GO2;

The gate electrode of MF2 and the drain electrode of MF2 are electrically connected to the first low voltage line VGL, and the source electrode of MF2 is electrically connected to the second driving signal output terminal GO2;

A first terminal of the second output capacitor CO2 is electrically connected to the second control node NC2, and a second terminal of the second output capacitor CO2 is electrically connected to the second driving signal output terminal GO2;

The gate electrode of MX21 is electrically connected to the first pull-down node PD1, the source electrode of MX21 is electrically connected to the second driving signal output terminal GO2, and the drain electrode of MX21 is electrically connected to the first low voltage line VGL;

The gate electrode of MX22 is electrically connected to the second pull-down node PD2, the source electrode of MX22 is electrically connected to the second driving signal output terminal GO2, and the drain electrode of MX22 is electrically connected to the first low voltage line VGL;

The third output sub-circuit may include a third first control transistor MC31, a third second control transistor MC32, a third output transistor MO3, a third shutdown reset transistor MF3, a third output capacitor CO3, a third first output pull-down transistor MX31 and a third second output pull-down transistor MX32;

The gate electrode of MC31 is electrically connected to the first control voltage line VDDo, the source electrode of MC31 is electrically connected to the driving control signal output terminal G01, and the drain electrode of MC31 is electrically connected to the third control node NC3;

The gate electrode of MC32 is electrically connected to the second control voltage line VDDe, the source electrode of MC32 is electrically connected to the driving control signal output terminal G01, and the drain electrode of MC32 is electrically connected to the third control node NC3;

The gate electrode of MO3 is electrically connected to the third control node NC3, the source electrode of MO3 is electrically connected to the third output clock signal line HC3, and the drain electrode of MO3 is electrically connected to the third driving signal output terminal GO3;

The gate electrode of MF3 and the drain electrode of MF3 are electrically connected to the first low voltage line VGL, and the source electrode of MF3 is electrically connected to the third driving signal output terminal GO3;

A first terminal of the third output capacitor CO3 is electrically connected to the third control node NC3, and a second terminal of the third output capacitor CO3 is electrically connected to the third driving signal output terminal GO3;

The gate electrode of MX31 is electrically connected to the first pull-down node PD1, the source electrode of MX31 is electrically connected to the third driving signal output terminal GO3, and the drain electrode of MX31 is electrically connected to the first low voltage line VGL;

The gate electrode of MX32 is electrically connected to the second pull-down node PD2, the source electrode of MX32 is electrically connected to the third driving signal output terminal GO3, and the drain electrode of MX32 is electrically connected to the first low voltage line VGL;

The fourth output sub-circuit may include a fourth first control transistor MC41, a fourth second control transistor MC42, a fourth output transistor MO4, a fourth shutdown reset transistor MF4, a fourth output capacitor CO4, a fourth first output pull-down transistor MX41 and a fourth second output pull-down transistor MX42;

The gate electrode of MC41 is electrically connected to the first control voltage line VDDo, the source electrode of MC41 is electrically connected to the driving control signal output terminal G01, and the drain electrode of MC41 is electrically connected to the fourth control node NC4;

The gate electrode of MC42 is electrically connected to the second control voltage line VDDe, the source electrode of MC42 is electrically connected to the driving control signal output terminal G01, and the drain electrode of MC42 is electrically connected to the fourth control node NC4;

The gate electrode of MO4 is electrically connected to the fourth control node NC4, the source electrode of MO4 is electrically connected to the fourth output clock signal line HC4, and the drain electrode of MO4 is electrically connected to the fourth driving signal output terminal GO4;

The gate electrode of MF4 and the drain electrode of MF4 are electrically connected to the first low voltage line VGL, and the source electrode of MF4 is electrically connected to the fourth driving signal output terminal GO4;

A first terminal of the fourth output capacitor CO4 is electrically connected to the fourth control node NC4, and a second terminal of the fourth output capacitor CO4 is electrically connected to the fourth driving signal output terminal GO4;

The gate electrode of MX41 is electrically connected to the first pull-down node PD1, the source electrode of MX41 is electrically connected to the fourth driving signal output terminal GO4, and the drain electrode of MX41 is electrically connected to the first low voltage line VGL;

The gate electrode of MX42 is electrically connected to the second pull-down node PD2, the source electrode of MX42 is electrically connected to the fourth driving signal output terminal GO4, and the drain electrode of MX42 is electrically connected to the first low voltage line VGL.

In one embodiment shown in FIG. 6, all transistors are n-type transistors, and all transistors are oxide thin film transistors, but the present invention is not limited thereto.

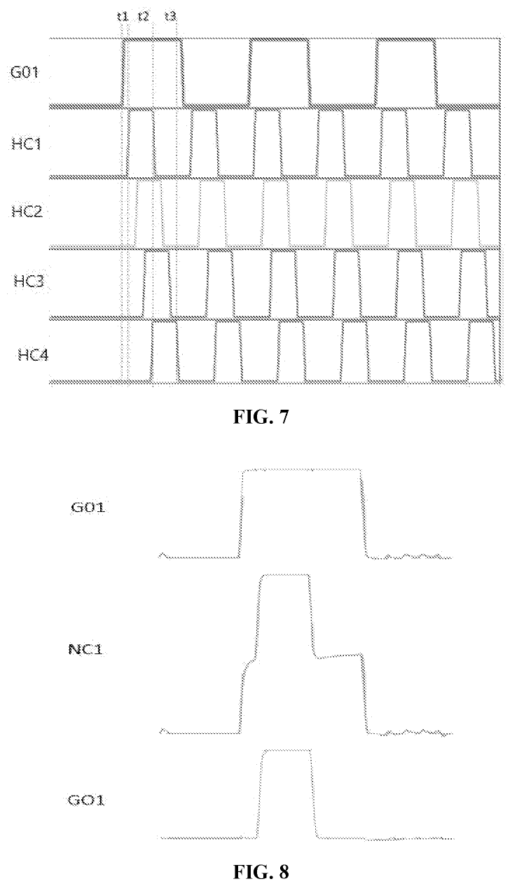

As shown in FIG. 7, when at least one embodiment of the present disclosure as shown in FIG. 6 is working, when VDDo provides a high voltage signal and VDDe provides a low voltage signal,

In the first phase t1, when G01 outputs a high voltage signal, MC11 is turned on to charge NC1;

In the second phase t2, MO1 is turned on, HC1 provides a high voltage signal to charge GO1, and at the same time, the potential of NC1 is further increased by the bootstrap effect of CO1 to ensure sufficient charging of GO1; it should be noted that MC11 is turned off at this time to prevent the potential of NC1 from failing to bootstrap;

In the third phase t3, MO1 is still in the on state, and HC1 provides a low voltage signal to discharge GO1;

In the period after this, the potential of PDo and the potential of PDe are high voltages; MX11 and MX12 are turned on to continuously discharge G01.

When one embodiment of the driving circuit shown in FIG. 6 of the present disclosure is in operation.

When G01 outputs a high voltage signal and HC2 outputs a high voltage signal, GO2 outputs a high voltage signal;

When G01 outputs a high voltage signal and HC3 outputs a low voltage signal, GO2 outputs a low voltage signal;

When G01 outputs a high voltage signal and HC3 outputs a high voltage signal, GO3 outputs a high voltage signal;

When G01 outputs a high voltage signal and HC3 outputs a low voltage signal, GO3 outputs a low voltage signal;

When G01 outputs a high voltage signal and HC4 outputs a high voltage signal, GO4 outputs a high voltage signal;

When G01 outputs a high voltage signal and HC4 outputs a low voltage signal, GO4 outputs a low voltage signal.

In at least one embodiment of the driving circuit shown in FIG. 6 of the present disclosure, the functions of each control transistor are described as follows: when VDDo provides a high voltage signal and VDDe provides a low voltage signal,

At the beginning of the first phase t1, the potential of NC1 is low voltage. For MC11, the gate-source voltage of MC11 is greater than the threshold voltage of MC11. The driving control signal output by G01 charges NC1. During the bootstrap process of the potential of NC1, the voltage of NC1 is greater than the high voltage value VGH, the gate-source voltage of MC11 is OV, and both MC11 and MC12 are in the off state.

Without MC11 and MC12, the potential of NC1 cannot complete self-bootstrapping. The reason is that the transistor whose gate electrode is electrically connected to the pull-up node PU included in the driving control output circuit on the left is in an on state, and the driving control clock signal line outputs a high voltage signal, which is an active signal. The bootstrapped charge will flow through the transistor to the driving control clock signal line, thereby failing to complete the bootstrapping of NC1.

FIG. 8 is the timing diagram of the driving control signal provided by G01, the potential of NC1 and the first driving signal output by GO1 when one embodiment of the driving circuit shown in FIG. 6 is working.

Optionally, the pull-up node control circuit includes a first transistor, a second transistor, a third transistor, a fourth transistor and a fifth transistor;

a gate electrode of the first transistor and a first electrode of the first transistor are electrically connected to the input terminal, and a second electrode of the first transistor is electrically connected to the pull-up node;

a gate electrode of the second transistor is electrically connected to the first reset terminal, a first electrode of the second transistor is electrically connected to the pull-up node, and a second electrode of the second transistor is electrically connected to the second voltage line;

a gate electrode of the third transistor is electrically connected to the frame reset line, a first electrode of the third transistor is electrically connected to the pull-up node, and a second electrode of the third transistor is electrically connected to the second voltage line;

a gate electrode of the fourth transistor is electrically connected to the first pull-down node, a first electrode of the fourth transistor is electrically connected to the pull-up node, and a second electrode of the fourth transistor is electrically connected to the second voltage line;

a gate electrode of the fifth transistor is electrically connected to the second pull-down node, a first electrode of the fifth transistor is electrically connected to the pull-up node, and a second electrode of the fifth transistor is electrically connected to the second voltage line;

The first pull-down node control circuit includes a sixth transistor and a seventh transistor;

a gate electrode of the sixth transistor and a first electrode of the sixth transistor are electrically connected to the first control voltage line, and a second electrode of the sixth transistor is electrically connected to the first pull-down node;

a gate electrode of the seventh transistor is electrically connected to the pull-up node, a first electrode of the seventh transistor is electrically connected to the first pull-down node, and a second electrode of the seventh transistor is electrically connected to the second voltage line;

The second pull-down node control circuit includes an eighth transistor and a ninth transistor;

a gate electrode of the eighth transistor and a first electrode of the eighth transistor are electrically connected to the second control voltage line, and a second electrode of the eighth transistor is electrically connected to the second pull-down node;

A gate electrode of the ninth transistor is electrically connected to the pull-up node, a first electrode of the ninth transistor is electrically connected to the second pull-down node, and a second electrode of the ninth transistor is electrically connected to the second voltage line.

Optionally, the first pull-down node control circuit further includes a tenth transistor, and the second pull-down node control circuit further includes an eleventh transistor;

a gate electrode of the tenth transistor is electrically connected to the input terminal, a first electrode of the tenth transistor is electrically connected to the first pull-down node, and a second electrode of the tenth transistor is electrically connected to the second voltage line;

a gate electrode of the eleventh transistor is electrically connected to the input terminal, a first electrode of the eleventh transistor is electrically connected to the second pull-down node, and a second electrode of the eleventh transistor is electrically connected to the second voltage line;

The carry output circuit includes a twelfth transistor, a thirteenth transistor and a fourteenth transistor;

a gate electrode of the twelfth transistor is electrically connected to the pull-up node, a first electrode of the twelfth transistor is electrically connected to the driving control clock signal line, and a second electrode of the twelfth transistor is electrically connected to the carry output terminal;

a gate electrode of the thirteenth transistor is electrically connected to the first pull-down node, a first electrode of the thirteenth transistor is electrically connected to the carry output terminal, and a second electrode of the thirteenth transistor is electrically connected to the second voltage line;

a gate electrode of the fourteenth transistor is electrically connected to the second pull-down node, a first electrode of the fourteenth transistor is electrically connected to the carry output terminal, and a second electrode of the fourteenth transistor is electrically connected to the second voltage line;

The driving control output circuit includes a fifteenth transistor, a sixteenth transistor, a seventeenth transistor, an eighteenth transistor and a first capacitor;

a gate electrode of the fifteenth transistor is electrically connected to the pull-up node, a first electrode of the fifteenth transistor is electrically connected to the driving control clock signal line, and a second electrode of the fifteenth transistor is electrically connected to the driving control signal output terminal;

a gate electrode of the sixteenth transistor is electrically connected to the first pull-down node, a first electrode of the sixteenth transistor is electrically connected to the driving control signal output terminal, and a second electrode of the sixteenth transistor is electrically connected to the first voltage line;

a gate electrode of the seventeenth transistor is electrically connected to the second pull-down node, a first electrode of the seventeenth transistor is electrically connected to the driving control signal output terminal, and a second electrode of the seventeenth transistor is electrically connected to the first voltage line;

a gate electrode of the eighteenth transistor is electrically connected to the second reset terminal, a first electrode of the eighteenth transistor is electrically connected to the driving control signal output terminal, and a second electrode of the eighteenth transistor is electrically connected to the first voltage line;

a first electrode plate of the first capacitor is electrically connected to the pull-up node, and a second electrode plate of the first capacitor is electrically connected to the driving control signal output terminal.

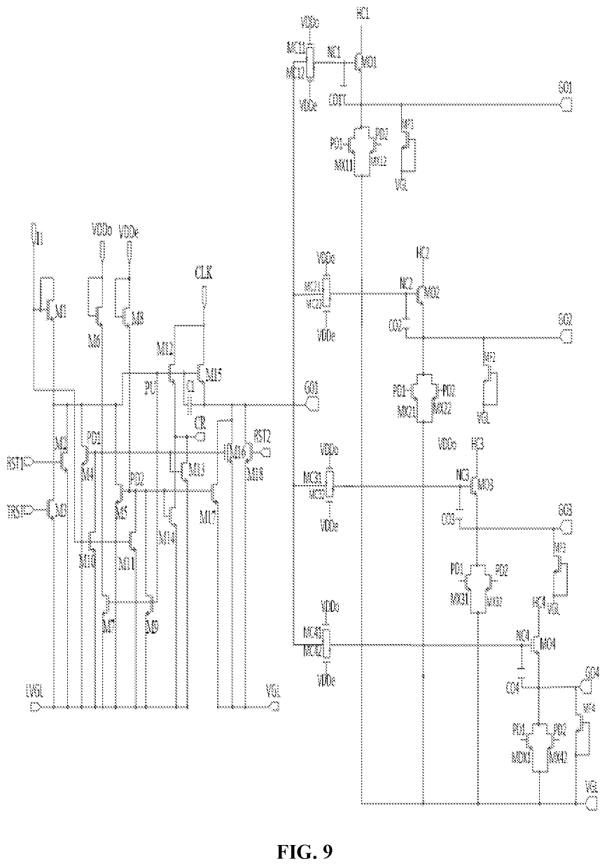

As shown in FIG. 9, based on one embodiment of the driving circuit shown in FIG. 6,

The pull-up node control circuit includes a first transistor M1, a second transistor M2, a third transistor M3, a fourth transistor M4 and a fifth transistor M5;

The gate electrode of the first transistor M1 and the drain electrode of the first transistor MI are electrically connected to the input terminal I1, and the source electrode of the first transistor M1 is electrically connected to the pull-up node PU;

The source electrode of the second transistor M2 is electrically connected to the first reset terminal RST1, the drain electrode of the second transistor M2 is electrically connected to the pull-up node PU, and the source electrode of the second transistor M2 is electrically connected to the second low voltage line LVGL;

The gate electrode of the third transistor M3 is electrically connected to the frame reset terminal TRST, the drain electrode of the third transistor M3 is electrically connected to the pull-up node PU, and the source electrode of the third transistor M3 is electrically connected to the second low voltage line LVGL;

The gate electrode of the fourth transistor M4 is electrically connected to the first pull-down node PD1, the drain electrode of the fourth transistor M4 is electrically connected to the pull-up node PU, and the source electrode of the fourth transistor M4 is electrically connected to the second low voltage line LVGL;

The gate electrode of the fifth transistor M5 is electrically connected to the second pull-down node PD2, the drain electrode of the fifth transistor M5 is electrically connected to the pull-up node PU, and the source electrode of the fifth transistor M5 is electrically connected to the second low voltage line LVGL;

The first pull-down node control circuit includes a sixth transistor M6 and a seventh transistor M7;

The gate electrode of the sixth transistor M6 and the drain electrode of the sixth transistor M6 are electrically connected to the first control voltage line VDDo, and the source electrode of the sixth transistor M6 is electrically connected to the first pull-down node PD1;

The gate electrode of the seventh transistor M7 is electrically connected to the pull-up node PU, the drain electrode of the seventh transistor M7 is electrically connected to the first pull-down node PD1, and the source electrode of the seventh transistor M7 is electrically connected to the second low voltage line LVGL;

The second pull-down node control circuit includes an eighth transistor M8 and a ninth transistor M9;

The gate electrode of the eighth transistor M8 and the drain electrode of the eighth transistor M8 are electrically connected to the second control voltage line VDDe, and the source electrode of the eighth transistor M8 is electrically connected to the second pull-down node PD2;

The gate electrode of the ninth transistor M9 is electrically connected to the pull-up node PU, the drain electrode of the ninth transistor M9 is electrically connected to the second pull-down node PD2, and the source electrode of the ninth transistor M9 is electrically connected to the second low voltage line LVGL;

The first pull-down node control circuit further includes a tenth transistor M10, and the second pull-down node control circuit 33 further includes an eleventh transistor M11;

A gate electrode of the tenth transistor M10 is electrically connected to the input terminal I1, a drain electrode of the tenth transistor M10 is electrically connected to the first pull-down node PD1, and a source electrode of the tenth transistor M10 is electrically connected to the second low voltage line LVGL;

The gate electrode of the eleventh transistor M11 is electrically connected to the input terminal I1, the drain electrode of the eleventh transistor M11 is electrically connected to the second pull-down node PD2, and the source electrode of the eleventh transistor M11 is electrically connected to the second voltage line LVGL;

The carry output circuit 35 includes a twelfth transistor M12, a thirteenth transistor M13 and a fourteenth transistor M14;

The gate electrode of the twelfth transistor M12 is electrically connected to the pull-up node PU, the drain electrode of the twelfth transistor M12 is electrically connected to the driving control clock signal line CLK, and the source electrode of the twelfth transistor M12 is electrically connected to the carry output terminal CR;

The gate electrode of the thirteenth transistor M13 is electrically connected to the first pull-down node PD1, the drain electrode of the thirteenth transistor M13 is electrically connected to the carry output terminal CR, and the source electrode of the thirteenth transistor M13 is electrically connected to the second low voltage line LVGL;

The gate electrode of the fourteenth transistor M14 is electrically connected to the second pull-down node PD2, the drain electrode of the fourteenth transistor M14 is electrically connected to the carry output terminal CR, and the source electrode of the fourteenth transistor M14 is electrically connected to the second low voltage line LVGL;

The driving control output circuit includes a fifteenth transistor M15, a sixteenth transistor M16, a seventeenth transistor M17, an eighteenth transistor M18 and a first capacitor C1;

The gate electrode of the fifteenth transistor M15 is electrically connected to the pull-up node PU, the drain electrode of the fifteenth transistor M15 is electrically connected to the driving control clock signal line CLK, and the source electrode of the fifteenth transistor M15 is electrically connected to the driving control signal output terminal G01;

The gate electrode of the sixteenth transistor M16 is electrically connected to the first pull-down node PD1, the drain electrode of the sixteenth transistor M16 is electrically connected to the driving control signal output terminal G01, and the source electrode of the sixteenth transistor M16 is electrically connected to the first low voltage line VGL;

The gate electrode of the seventeenth transistor M17 is electrically connected to the second pull-down node PD2, the drain electrode of the seventeenth transistor M17 is electrically connected to the driving control signal output terminal G01, and the source electrode of the seventeenth transistor M17 is electrically connected to the first low voltage line VGL;

The gate electrode of the eighteenth transistor M18 is electrically connected to the second reset terminal RST2, the drain electrode of the eighteenth transistor M18 is electrically connected to the driving control signal output terminal G01, and the source electrode of the eighteenth transistor M18 is electrically connected to the first low voltage line VGL;

The first electrode plate of the first capacitor C1 is electrically connected to the pull-up node PU, and the second electrode plate of the first capacitor C1 is electrically connected to the driving control signal output terminal G01.

In one embodiment of the driving circuit shown in FIG. 9, all transistors are n-type transistors, and all transistors are oxide thin film transistors, but the present invention is not limited thereto.

In one embodiment of the driving circuit shown in FIG. 9, the width-to-length ratio of M1 may be greater than or equal to 12 and less than or equal to 15, the width-to-length ratio of M2 may be greater than or equal to 2 and less than or equal to 5, the width-to-length ratio of M15 may be greater than or equal to 100 and less than or equal to 300, the width-to-length ratio of M18 may be greater than or equal to 4 and less than or equal to 6, the width-to-length ratio of M6 and the width-to-length ratio of M8 may be greater than or equal to 0.8 and less than or equal to 1.2, the width-to-length ratio of M7 and the width-to-length ratio of M9 may be greater than or equal to 4 and less than or equal to 4.8, the width-to-length ratio of M10 and the width-to-length ratio of M11 may be greater than or equal to 3 and less than or equal to 5, the width-to-length ratio of M4 and the width-to-length ratio of M5 may be greater than or equal to 13 and less than or equal to 15, the width-to-length ratio of M12 may be greater than or equal to 70 and less than or equal to 90, the width-to-length ratio of M13 and the width-to-length ratio of M14 may be greater than or equal to 1 and less than or equal to 3, the width-to-length ratio of M16 and the width-to-length ratio of M17 may be greater than or equal to 7 and less than or equal to 9, the width-to-length ratio of M3 may be greater than or equal to 0.8 and less than or equal to 1.2, the width-to-length ratio of each control transistor may be greater than or equal to 40 and less than or equal to 80, the width-to-length ratio of each output transistor may be greater than or equal to 100 and less than or equal to 200, the width-to-length ratio of each output pull-down transistor may be greater than or equal to 7 and less than or equal to 9, the capacitance value of the first capacitor may be greater than or equal to 1 pF and less than or equal to 3 pF, and the capacitance value of each output capacitor may be greater than or equal to 1 pF and less than or equal to 3 pF.

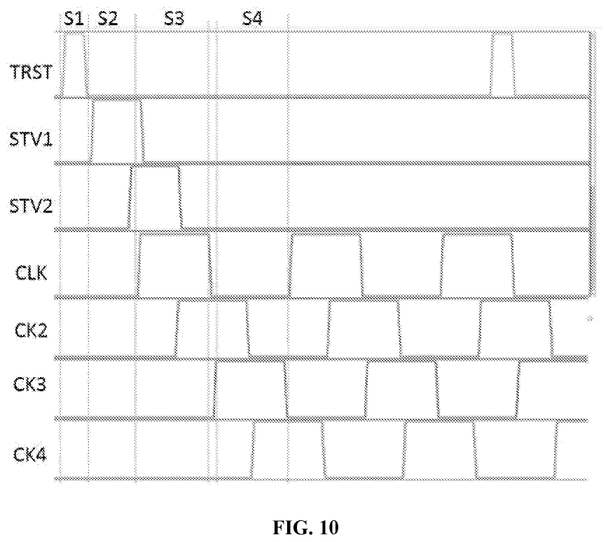

As shown in FIG. 10, when at least one embodiment of the driving circuit shown in FIG. 9 of the present disclosure is in operation, a display cycle may include a first display phase S1, a second display phase S2, a third display phase S3, a fourth display phase S4, and a fifth display phase S5;

In the first display phase S1, TRST provides a high voltage signal, M3 is turned on, other transistors are turned off, and low voltage signals are written to the pull-up nodes in all row of driving circuits. TRST connects all row of driving circuits to reduce noise for all rows of driving circuits before the frame. The function of the frame reset signal provided by TRST is to prevent the signal abnormality of the front terminal of the gate driving architecture (such as the timing control chip), which causes the noise to be transmitted to the next frame.

In the second display phase S2, STV1 is a high voltage signal (the input terminal I1 in FIG. 9 is connected to the first start signal STV1), M1 is turned on, M10 and M11 are turned on, and other transistors are turned off. M1 writes a high voltage signal to PU, M10 writes a low voltage signal to PD1, and M11 writes a low voltage signal to PD2. This design can reduce the discharge current passing through M10 and M11 when charging PU; when PU is charged to a certain extent (usually when the potential of PU rises to more than 2V), M15 is turned on, G01 outputs a low voltage signal, and M7 and M9 are turned on to write low voltage signals to PD1 and PD2;

In the third display phase S3, M15 is turned on, CLK outputs a high voltage signal, M15 is turned on, M7 and M9 remain on, G01 outputs a high voltage signal, and the potential of PU is further increased under the bootstrap effect of C1;

In the fourth display phase S4, RST1 provides a high voltage signal, M2 is turned on, a low voltage signal is written to PU, M7 and M9 are turned off, VDDo writes a high voltage to PD1 through M6, VDDe writes a high voltage to PD2 through M8, M4, M5, M13, M14, M16 and M17 are all turned on, and noise reduction is continuously performed for PU, CR and G01, the potential of PU is a low voltage, and CR and G01 both output low voltage signals;

In the time period after the fourth display phase S4, the potential of PD1 and the potential of PD2 are both high voltages, and M4, M5, M13, M14, M16 and M17 are continuously controlled to be turned on, and PU, CR and G01 are continuously noise-reduced until the terminal of this frame.

In FIG. 10, the signal labeled CK2 is the second driving control clock signal, the signal labeled CK3 is the third driving control clock signal, and the signal labeled CK4 is the fourth driving control clock signal;

In a specific implementation, when the first stage of driving circuit is electrically connected to CLK in FIG. 10, the second stage of driving circuit can be connected to CK2, the third stage of driving circuit can be connected to CK3, and the fourth stage of driving circuit can be connected to CK4; A is a positive integer;

The input terminal of the first stage of driving circuit is connected to the first start signal STV1, and the input terminal of the second stage of driving circuit is connected to the second start signal STV2 (STV2 is shown in FIG. 10) ;

The input terminal of the third stage of driving circuit can be electrically connected to the driving control signal output terminal of the first stage of driving circuit, and the input terminal of the fourth stage of driving circuit can be electrically connected to the driving control signal output terminal of the second stage of driving circuit;

The first reset terminal of the first stage of driving circuit can be electrically connected to the driving control signal output terminal of the third stage of driving circuit, and the first reset terminal of the second stage of driving circuit can be electrically connected to the driving control signal output terminal of the fourth stage of driving circuit.

In actual operation, the driving module can be electrically connected to eight output clock signal lines, the odd-numbered stages of driving circuits included in the driving module are electrically connected to the first output clock signal line, the second output clock signal line, the third output clock signal line and the fourth output clock signal line, respectively, and the even-numbered stages of driving circuits included in the driving module are electrically connected to the fifth output clock signal line, the sixth output clock signal line, the seventh output clock signal line and the eighth output clock signal line, respectively.

In at least one embodiment of the present disclosure, the driving circuit includes an input terminal and a driving control signal output terminal;

The input terminal of the Bth stage of driving circuit is electrically connected to the driving control signal output terminal of the (B−2)th stage of driving circuit, and the reset terminal of the Ath stage of driving circuit is electrically connected to the driving control signal output terminal of the (A+2)th stage of driving circuit.

A is a positive integer, B is an integer greater than 2;

The input terminal of the first stage of driving circuit is connected to the first start signal, and the input terminal of the second stage of driving circuit is connected to the second start signal.

An embodiment of the present disclosure includes a base substrate and a plurality of stages of the driving circuits arranged on the base substrate.

In at least one embodiment of the present disclosure, the display substrate includes a peripheral area and a display area; the driving circuit includes a driving control signal generation circuit and a multi-channel output circuit;

The multi-channel output circuit and the driving control signal generation circuit are arranged in the peripheral area;

The multi-channel output circuit is arranged on a side of the driving control signal generation circuit close to the display area.

In a specific implementation, the driving circuit can be arranged in the peripheral area, and the multi-channel output circuit is arranged on the side of the driving control signal generation circuit close to the display area, so that the driving signal output terminals respectively included in the multi-channel output circuit are electrically connected to each row of gate line in the display area.

Optionally, the multi-channel output circuit includes N output sub-circuits and N output clock signal lines; N is an integer greater than 1;

The output clock signal line is arranged on a side of the output sub-circuit close to the display area, and the output clock signal line extends along a first direction.

In a specific implementation, each of the output clock signal lines is arranged on a side of the output sub-circuit close to the display area, which is beneficial to reducing the crossover distance between the output sub-circuit and the output clock signal line and saving space.

Optionally, the nth output sub-circuit includes an nth control unit and an nth output unit; n is a positive integer less than or equal to N;

The nth control unit is arranged on a side of the nth output unit away from the display area.

In a specific implementation, the nth output sub-circuit may include an nth control unit and an nth output unit, and the nth control unit may be arranged on a side of the nth output unit away from the display area.

Optionally, the active pattern of the transistor included in the nth control unit includes at least one active portion independent of each other, and the active pattern of the transistor included in the nth output unit includes at least one active portion independent of each other.

In at least one embodiment of the present disclosure, the extension direction of part of the active portion and the extension direction of the output clock signal line may both be a first direction. For example, the first direction may be vertical direction, but is not limited thereto.

Optionally, the active layer pattern of at least one transistor included in the driving circuit may include at least two active pattern portions extending along the first direction;

A distance between two adjacent active pattern portions in the fourth direction is greater than a first predetermined distance.

Optionally, the first direction may be a vertical direction, and the fourth direction may be a horizontal direction.

For example, the first predetermined distance may be 3 μm, but is not limited thereto.

In at least one embodiment of the present disclosure, the active layer pattern of the transistor in the driving circuit may be a long strip active layer pattern extending in the vertical direction, so as to facilitate the realization of a narrow frame. When there is no narrow frame requirement, the active layer pattern of the transistor may include at least two active pattern portions extending in the vertical direction, and the distance between each two adjacent active pattern portions in the horizontal direction is greater than or equal to 3 μm, so as to facilitate heat dissipation and improve the performance of the transistor.

Optionally, the nth output sub-circuit includes an nth shutdown reset unit, an nth output capacitor and an nth output pull-down unit;

The nth output pull-down unit is arranged between the nth shutdown reset unit and the nth output capacitor;

The nth output capacitor is arranged between the nth output unit and the nth output pull-down unit;

The output capacitors respectively included in the N output sub-circuits are arranged along a first direction;

The active layer patterns of transistors in the shutdown reset units included in the N output sub-circuits are arranged along a first direction;

Active layer patterns of transistors in output pull-down units included in the N output sub-circuits are arranged along a first direction.

In a specific implementation, the nth output sub-circuit may include an nth shutdown reset unit, an nth output capacitor and an nth output pull-down unit. The nth output pull-down unit may be arranged between the nth shutdown reset unit and the nth output capacitor. The output capacitors included in the N output sub-circuits may be arranged along a first direction. The active layer patterns of the transistors in the shutdown reset units included in the N output sub-circuits may be arranged along the first direction. The active layer patterns of the transistors in the output pull-down units included in the N output sub-circuits may be arranged along the first direction.

The display substrate in at least one embodiment of the present disclosure further includes a driving control clock signal line, a frame reset line, a first voltage line, a second voltage line, a first control voltage line, and a second control voltage line;

The driving control clock signal line, the frame reset line, the first voltage line, the second voltage line, the first control voltage line and the second control voltage line are arranged on a side of the driving control signal generation circuit away from a display area.

In a specific implementation, the driving control clock signal line, the frame reset line, the first voltage line, the second voltage line, the first control voltage line and the second control voltage line included in the display substrate can be arranged on a side of the driving control signal generation circuit away from the display area.

Optionally, a channel width-to-length ratio of a transistor included in the nth control unit is greater than or equal to 40 and less than or equal to 80;

The nth output unit includes a transistor having a channel width-to-length ratio greater than or equal to 100 and less than or equal to 200;

But it is not limited to this.

In at least one embodiment of the present disclosure, the semiconductor layer includes a conductive region, a transition region and a channel region, wherein the conductive region is connected to the source electrode and the drain electrode of the transistor, the channel region refers to the semiconductor layer in the area overlapping with the gate electrode when the semiconductor layer is viewed from a top view, and the transition region is located between the conductive region and the channel region.

The display substrate in at least one embodiment of the present disclosure further includes a plurality of rows of gate lines, a plurality of columns of data lines and a plurality of pixels arranged in the display area;

The pixel includes M sub-pixels with different colors; M is an integer greater than or equal to 3;

The sub-pixel comprises a switch transistor and a pixel electrode; the pixel electrode comprises at least one pixel electrode portion electrically connected to each other;

The pixel electrode portion extends along the second direction, the gate line extends along the third direction, and the data line extends along the first direction;

The second direction is substantially the same as the third direction, the first direction intersects the second direction, and the first direction intersects the third direction;

A row of gate lines is arranged between two adjacent rows of sub-pixels, and a column of data lines is arranged between two adjacent columns of sub-pixels;

The gate electrode of the switch transistor is electrically connected to the corresponding gate line, the first electrode of the switch transistor is electrically connected to the pixel electrode, and the second electrode of the switch transistor is electrically connected to the corresponding data line.

In at least one embodiment of the present disclosure, in the display area, a pixel electrode portion included in a pixel electrode of each sub-pixel extends along a second direction, and the extending direction of the pixel electrode portion is substantially the same as the extending direction of the gate line.

The existing TDDI (Touch and Display Driver Integration) products have a large number of S-ICs (source divers), and the price of S-ICs is high, resulting in a high cost of current TDDI products. To address this problem, at least one embodiment of the present disclosure adopts a pixel structure design of three gate electrodes for TDDI display product. In this pixel structure, the pixel electrode is horizontally arranged, the number of gate lines is three times that of a normal display product, and the number of data lines is one-third of that of a normal display product, ensuring that the resolution of the display product remains unchanged while greatly reducing the number of data lines. At the same time, due to the increase in the number of gate lines, the use of a gate driving architecture that uses a row of GOA architectures to drive a row of pixels will increase the left and right borders of the display product. Based on this, the embodiments of the present disclosure propose a multiplexed gate driving architecture.

Optionally, the gate line includes a first terminal and a second terminal;

The driving circuit is electrically connected to the signal input terminal of the gate line, and is configured to provide a driving signal to the gate line through the signal input terminal; the signal input terminal is the first terminal or the second terminal;

The display substrate further comprises a plurality of electrostatic discharge blocks arranged on the base substrate; the electrostatic discharge blocks are conductive blocks;

The electrostatic discharge block is electrically connected to a terminal of the gate line other than the signal input terminal.

In a specific implementation, a gate line with a blunt terminal is designed to reduce the tip discharge at the terminal of the gate line, thereby improving ESD (electrostatic discharge).

In at least one embodiment of the present disclosure, the driving circuit is electrically connected to the signal input terminal of the gate line, and a driving signal is provided to the gate line through the signal input terminal. The display panel sets an electrostatic discharge block at the terminal of the gate line other than the signal input terminal, and the electrostatic discharge block is electrically connected to the terminal of the gate line other than the signal input terminal to prevent discharge at the tip terminal of the gate line.

Optionally, the electrostatic discharge block and the gate line are arranged in the same layer and made of the same material.

The electrostatic discharge block may be a conductive block, and the electrostatic discharge block may be arranged in a same layer and made of a same material as the gate line.

Optionally, an orthographic projection of the electrostatic discharge block on the base substrate may be a square or a rectangle, but is not limited thereto.

In at least one embodiment of the present disclosure, a length of the electrostatic discharge block along the first direction is greater than a line width of the gate line.

Optionally, the first direction may be a vertical direction.

In a specific implementation, the width of the electrostatic discharge block is greater than the line width of the gate line. For example, the line width of the gate line can be 3.5 μm, and the side length of the orthographic projection of the electrostatic discharge block on the base substrate can be 18 μm. The electrostatic discharge block can prevent discharge at the tip terminal of the gate line.

Optionally, the side length of the orthographic projection of the electrostatic discharge block on the base substrate is greater than or equal to 12 μm and less than or equal to 30 μm, and the line width of the gate line is greater than or equal to 3 μm and less than or equal to 4 μm.

Optionally, a channel width-to-length ratio of the switch transistor is greater than or equal to 0.8 and less than or equal to 2, and a channel length of the switch transistor is greater than or equal to 3 μm and less than or equal to 6 μm.

In at least one embodiment of the present disclosure, an increase in the line width of the gate line will affect the aperture ratio, and a decrease in the line width of the gate line will increase the gate line resistance, affecting pixel charging. Therefore, in at least one embodiment of the present disclosure, the line width of the gate line is set between 3 μm and 4 μm, and the channel width-to-length ratio of the thin film transistor in the pixel circuit is 5/4. An increase in the channel width of the thin film transistor affects the aperture ratio, and an increase in the channel width of the thin film transistor will reduce the charging rate; an increase in the channel length of the thin film transistor affects the aperture ratio and reduces the charging rate at the same time; a decrease in the channel length of the thin film transistor will have the risk of channel short circuit, and the channel length of the thin film transistor is between 3 μm and 6 μm.

The display substrate in at least one embodiment of the present disclosure further includes a plurality of columns of touch signal lines;

The touch signal line is arranged between two columns of sub-pixels, and the touch signal line is arranged adjacent to the data line;

The display substrate further comprises a common electrode, and the common electrode comprises a plurality of common electrode blocks which are independent of each other; the pixel electrode is arranged on a side of the common electrode away from the base substrate;

The touch signal line is electrically connected to the common electrode block through a first via hole.

In a specific implementation, a column of touch signal line is arranged between two columns of sub-pixels, the touch signal line is arranged adjacent to the data line, the touch signal line is electrically connected to the common electrode block through the first via hole, and the touch signal line can be made of a source-drain metal layer.

Optionally, the touch signal line and the data line are arranged in the same layer; the display substrate further comprises a conductive pattern arranged in the same layer as the pixel electrode;

The conductive pattern is electrically connected to the touch signal line and the common electrode block respectively through the first via hole, so that the touch signal line is electrically connected to the common electrode block; the pixel electrode includes a plurality of pixel electrode portions;

At least one pixel electrode portion included in the pixel electrode and the conductive pattern are arranged along a fourth direction;

a length of at least one pixel electrode portion along the fourth direction is smaller than a length of a pixel electrode portion of the pixel electrode other than the at least one pixel electrode portion along the fourth direction.

In a specific implementation, since the conductive pattern can be in the same layer as the pixel electrode, in order to set the conductive pattern, the length of at least one pixel electrode portion along the fourth direction can be smaller than the length of the pixel electrode portion other than the at least one pixel electrode portion included in the pixel electrode along the fourth direction, so as to set the conductive pattern around the pixel electrode having a smaller length along the fourth direction.

Optionally, the fourth direction may be a horizontal direction.

In at least one embodiment of the present disclosure, the first via hole includes a first via hole portion and a second via hole portion, and the touch signal line, the common electrode block and the conductive pattern are arranged in sequence along a direction away from the base substrate;

The conductive pattern is electrically connected to the touch signal line through the first via portion, and the conductive pattern is electrically connected to the common electrode block through the second via portion.

Optionally, the touch signal line is formed in a source-drain metal layer, the common electrode block is formed in a first conductive layer, and the pixel electrode is formed in a second conductive layer;

The source-drain metal layer, the first conductive layer and the second conductive layer are arranged in sequence along a side away from the display substrate.

at least one embodiment of the present disclosure further includes a virtual sub-pixel;

The virtual sub-pixel is arranged in the peripheral area, and the virtual sub-pixel is arranged adjacent to the display area;

The length of the virtual sub-pixel along the fourth direction is smaller than the length of the sub-pixel along the fourth direction.

In a specific implementation, virtual sub-pixels are arranged around the display area, and the length of the virtual sub-pixels along the third direction may be smaller than the length of the normal sub-pixels along the fourth direction.

FIGS. 11A and 11B are layout diagrams of at least one embodiment of the driving circuit shown in FIG. 9.

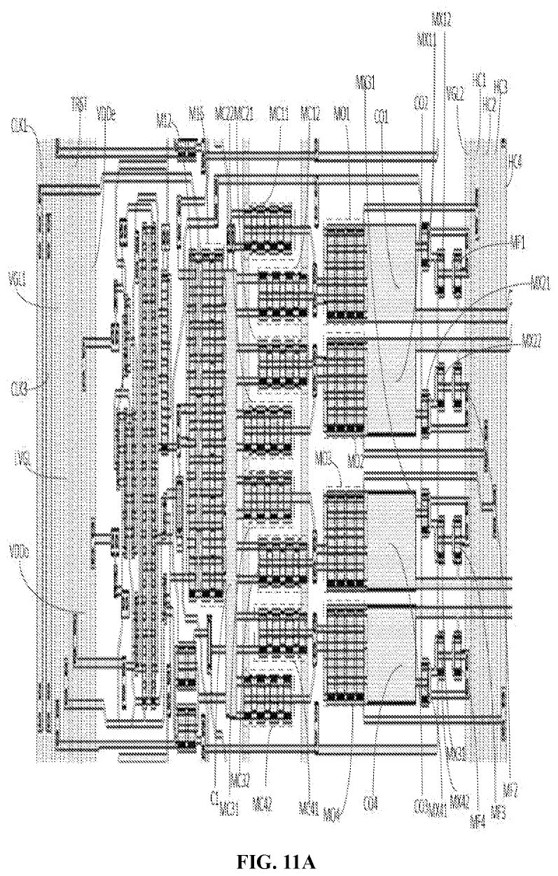

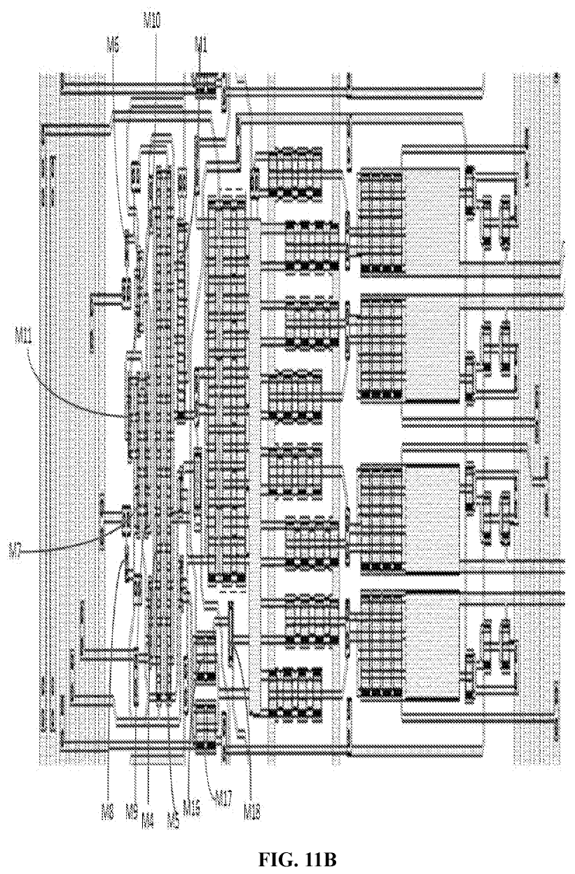

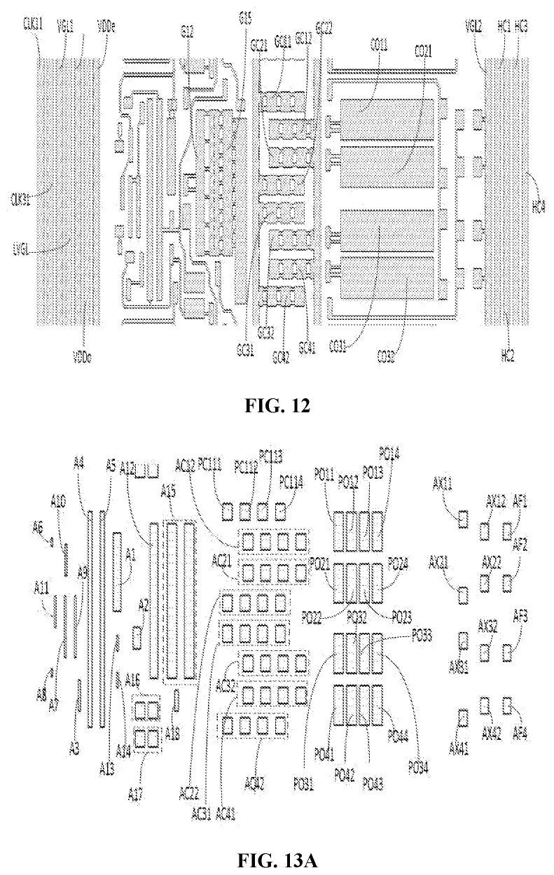

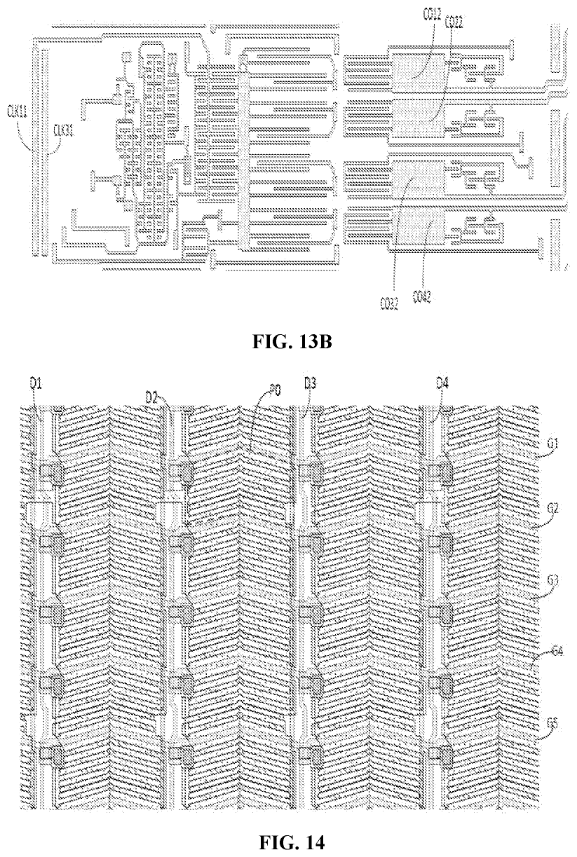

FIG. 12 is a layout diagram of the gate metal layer in FIG. 11A, FIG. 13A is a layout diagram of the semiconductor layer in FIG. 11A, and FIG. 13B is a layout diagram of the source-drain metal layer in FIG. 11A.

In FIG. 11A, CLK1 is the first clock signal line, CLK3 is the third clock signal line, VGL1 is the first first low voltage line, VGL2 is the second first low voltage line, LVGL is the second low voltage line, HC1 is the first output clock signal line, HC2 is the second output clock signal line, HC3 is the third output clock signal line, HC4 is the fourth output clock signal line, VDDo is the first control voltage line, and VDDe is the second control voltage line.

In FIG. 12, the first clock signal line portion labeled CLK11 is included in the first clock signal line, and the first clock signal line portion labeled CLK31 is included in the third clock signal line;

In FIG. 13B, the second clock signal line portion included in the first clock signal line is labeled CLK12, and the second clock signal line portion included in the third clock signal line is labeled CLK32. As shown in FIG. 11A-FIG. 13B, the orthographic projection of CLK11 on the base substrate at least partially overlaps the orthographic projection of CLK12 on the base substrate, and the orthographic projection of CLK21 on the base substrate at least partially overlaps the orthographic projection of CLK22 on the base substrate, and CLK11, CLK12, CLK21 and CLK22 all extend in the vertical direction.

In FIG. 12, CO11 is the first electrode plate of CO1, CO21 is the first electrode plate of CO2, CO31 is the first electrode plate of CO3, and CO41 is the first electrode plate of CO4;

In FIG. 13B, CO12 is the second electrode plate of CO1, CO22 is the second electrode plate of CO2, CO32 is the second electrode plate of CO3, and CO42 is the second electrode plate of CO4.

In FIG. 12, the one labeled G12 is the gate electrode of M12, the one labeled G15 is the gate electrode of M15, the one labeled GC11 is the gate electrode of MC11, the one labeled GC12 is the gate electrode of MC12, the one labeled GC21 is the gate electrode of MC21, the one labeled GC22 is the gate electrode of MC12, the one labeled GC31 is the gate electrode of MC31, the one labeled GC32 is the gate electrode of MC32, the one labeled GC41 is the gate electrode of MC41, and the one labeled GC42 is the gate electrode of MC12.

As shown in FIG. 12, G12, G15, GC11, GC12, GC21, GC22, GC31, GC32, GC41 and GC42 are provided with a hollow structure to facilitate heat dissipation, so that under the premise that the mobility of the transistor is relatively large, the characteristics of M12, M15, MC11, MC12, MC21, MC22, MC31, MC32, MC41 and MC42 will not produce a large drift, which is beneficial to the output stability of the driving circuit.

As shown in FIG. 11A, the capacitors and transistors included in the multi-channel output circuit, and the capacitors and transistors included in the driving control signal generation circuit are all arranged in the peripheral area;

The capacitor and transistor included in the multi-channel output circuit are arranged on a side of the driving control signal generation circuit close to the display area, that is, on the right side of the driving control signal generation circuit in the display area.

As shown in FIG. 11A, the first output clock signal line HC1, the second output clock signal line HC2, the third output clock signal line HC3, and the fourth output clock signal line HC4 may all extend in a vertical direction;

Each output clock signal line is arranged on a side of the capacitor and transistor included in the output sub-circuit close to the display area.

As shown in FIG. 11A, the first output sub-circuit includes MO1, MC11, MC12, CO1, MX11, MX12, and MF1;

The second output sub-circuit includes MO2, MC21, MC22, CO2, MX21, MX22 and MF2;

The third output sub-circuit includes MO3, MC31, MC32, CO3, MX31, MX32 and MF3;

The fourth output sub-circuit includes MO4, MC41, MC42, CO4, MX41, MX42 and MF4;

HC1, HC2, HC3 and HC4 are arranged on the side of the first output sub-circuit, the second output sub-circuit, the third output sub-circuit and the fourth output sub-circuit close to the display area, which is beneficial to reducing the crossover distance between the output sub-circuit and the output clock signal line and saving space.

As shown in FIG. 11A, MC11 and MC12 are arranged on a side of MO1 away from the display area, MC21 and MC22 are arranged on a side of MO2 away from the display area, MC31 and MC32 are arranged on a side of MO3 away from the display area, and MC41 and MC42 are arranged on a side of MO4 away from the display area.

As shown in FIG. 13A, the active pattern of MO1 includes four active portions that are independent of each other; the active pattern of MO2 includes four active portions that are independent of each other; the active pattern of MO3 includes four active portions that are independent of each other; the active pattern of MO4 includes four active portions that are independent of each other;

The first active portion of MO1 is labeled PO11, the second active portion of MO1 is labeled PO12, the third active portion of MO1 is labeled PO13, and the fourth active portion of MO1 is labeled PO14; PO11, PO12, PO13 and PO14 are block-shaped active portions;

The first active portion of MO2 is labeled PO21, the second active portion of MO2 is labeled PO22, the third active portion of MO2 is labeled PO23, and the fourth active portion of MO2 is labeled PO24; PO21, PO22, PO23 and PO24 are block-shaped active portions;

The first active portion of MO3 is labeled PO31, the second active portion of MO3 is labeled PO32, the third active portion of MO3 is labeled PO33, and the fourth active portion of MO3 is labeled PO34; PO31, PO32, PO33 and PO34 are block-shaped active portions;

The first active portion of MO4 is labeled PO41, the second active portion of MO4 is labeled PO42, the third active portion of MO4 is labeled PO43, and the fourth active portion of MO4 is labeled PO44; PO41, PO42, PO43 and PO44 are block-shaped active portions;

The active pattern of MC11 includes four mutually independent active portions, and the active patterns of other control transistors also include four mutually independent active portions;

The first active portion of MC11 is labeled by PC111, the second active portion of MC11 is labeled by PC112, the third active portion of MC11 is labeled by PC113, and the fourth active portion of MC11 is labeled by PC114; PC111, PC112, PC113 and PC114 are block-shaped active portions;

The active pattern of MC12 is labeled A12, and AC12 includes four independent block-shaped active portions;

The active pattern of MC21 is labeled A21, and AC21 includes four independent block-shaped active portions;

The active pattern of MC22 is labeled AC22, and AC22 includes four independent block-shaped active portions;

The active pattern of MC31 is labeled AC31, and AC31 includes four independent block-shaped active portions;

The active pattern of MC32 is labeled AC32, and AC32 includes four independent block-shaped active portions;

The active pattern of MC41 is labeled AC41, and AC41 includes four independent block-shaped active portions;

The active pattern of MC42 is labeled AC42, and AC42 includes four independent block-shaped active portions.

As shown in FIG. 13A, the extension direction of the active portion of each output transistor and the extension direction of each output clock signal line may both be vertical directions, but not limited thereto.

As shown in FIG. 13A, the distance between adjacent active portions of each output transistor in the horizontal direction may be greater than 3 μm, but is not limited thereto.

In FIG. 13A, A12 is an active pattern of M12, A15 is an active pattern of M15, and A15 includes two strip-shaped active portions extending in the vertical direction;

The active pattern of M1 is labeled A1, and A1 is a strip-shaped active pattern; A1 extends in the vertical direction;

The active pattern of M2 is labeled A2, and A2 is a block active pattern;

The active pattern of M3 is labeled A3, A3 is a strip-shaped active pattern; A3 extends in the vertical direction;

The active pattern of M4 is labeled A4, A4 is a strip-shaped active pattern; A4 extends in the vertical direction;

The active pattern of M5 is labeled A5, and A5 is a strip-shaped active pattern; A5 extends in the vertical direction;

The active pattern of M6 is labeled A6, and A6 is a block active pattern;

The active pattern of M7 is labeled A7, and A7 includes two block-shaped active portions that are independent of each other;

The active pattern of M8 is labeled A8, and A8 is a block active pattern;

The active pattern of M9 is labeled A9, and A9 is a strip-shaped active pattern; A9 extends in the vertical direction;

The active pattern of M5 is labeled A10, and A10 is a strip-shaped active pattern; A10 extends in the vertical direction;

The active pattern of M11 is labeled A11, and All is a strip-shaped active pattern; A11 extends in the vertical direction;

The active pattern of M12 is labeled A12, and A12 is a strip-shaped active pattern; A12 extends in the vertical direction;

The active pattern of M13 is labeled A13, A13 is a strip-shaped active pattern; A13 extends in the vertical direction;

The active pattern of M14 is labeled A14, A14 is a strip-shaped active pattern; A14 extends in the vertical direction;

The active pattern of M15 is labeled A15, and A15 includes two strip-shaped active portions extending in the vertical direction and independent of each other;

The active pattern of M16 is labeled A16, and A16 includes two block-shaped active portions that are independent of each other;

The active pattern of M17 is labeled A17, and A17 includes two block-shaped active portions that are independent of each other;

The active pattern of M18 is labeled A18, and A18 is a block active pattern;

AX11 is the active pattern of MX11, AX12 is the active pattern of MX12, AX21 is the active pattern of MX21, AX22 is the active pattern of MX12, AX31 is the active pattern of MX31, AX32 is the active pattern of MX32, AX41 is the active pattern of MX41, AX42 is the active pattern of MX42, and AX11, AX12, AX21, AX22, AX31, AX32, AX41 and AX42 are block active patterns;

AF1 is an active pattern of MF1, AF2 is an active pattern of MF2, AF3 is an active pattern of MF3, AF4 is an active pattern of MF4, and AF1, AF2, AF3 and AF4 are block active patterns.

As shown in FIG. 11A, the first output sub-circuit may include a first shutdown reset transistor MF1, a first output capacitor CO1, a first first output pull-down transistor MX11, a first second output pull-down transistor MX12, and a first output transistor MO1;

MX11 and MX12 are set between MF1 and CO1; CO1 is set between MO1 and MX11;

The second output sub-circuit may include a second shutdown reset transistor MF2, a second output capacitor CO2, a second first output pull-down transistor MX21, a second second output pull-down transistor MX22, and a second output transistor MO2;

MX21 and MX22 are set between MF2 and CO2; CO2 is set between MO2 and MX21;

The third output sub-circuit may include a third shutdown reset transistor MF3, a third output capacitor CO3, a third first output pull-down transistor MX31, a third second output pull-English down transistor MX32, and a third output transistor MO3;

MX31 and MX32 are set between MF3 and CO3; CO3 is set between MO3 and MX31;

The fourth output sub-circuit may include a fourth shutdown reset transistor MF4, a fourth output capacitor CO4, a fourth first output pull-down transistor MX41, a fourth second output pull-down transistor MX42, and a fourth output transistor MO4;

MX41 and MX42 are set between MF4 and CO4; CO4 is set between MO4 and MX41;

CO1, CO2, CO3 and CO4 are arranged in sequence along the vertical direction;

The active layer pattern of MF1, the active layer pattern of MF2, the active layer pattern of MF3 and the active layer pattern of MF4 are arranged in sequence along the vertical direction;

The active layer pattern of MX11, the active layer pattern of MX21, the active layer pattern of MX31 and the active layer pattern of MX41 are arranged in sequence along the vertical direction;

The active layer pattern of MX12, the active layer pattern of MX22, the active layer pattern of MX32, and the active layer pattern of MX42 are sequentially arranged along the vertical direction.

In a specific implementation, the output capacitors are arranged in sequence along the vertical direction, active layer patterns of the shutdown reset transistors are arranged in sequence along the vertical direction, and active layer patterns of the output pull-down transistors are arranged in sequence along the vertical direction, so as to save horizontal space and realize a narrow frame.

As shown in FIG. 11A and FIG. 11B, the first clock signal line CLK1, the third clock signal line CLK3, VGL1, TRST, LVGL, VDDo and VDDe are arranged on a side of the region away from the driving control signal generation circuit;

The first clock signal line CLK1 and the third clock signal line CLK3 are driving control clock signal lines.

In a specific implementation, the odd-numbered stages of driving circuits can be arranged on the left side of the display area, and the even-numbered stages of driving circuits can be arranged on the right side of the display area. The driving control clock signal lines of adjacent odd-numbered stages of driving circuits can be the first clock signal line and the third clock signal line, respectively, and the driving control clock signal lines of adjacent even-numbered stages of driving circuits can be the second clock signal line and the fourth clock signal line, respectively.

In a specific implementation, the channel width-to-length ratio of MC11, the channel width-to-length ratio of MC12, the channel width-to-length ratio of MO21, the channel width-to-length ratio of MO22, the channel width-to-length ratio of MC31, the channel width-to-length ratio of MC32, the channel width-to-length ratio of MO41, and the channel width-to-length ratio of MO 42 may be equal to or equal to 40 and less than or equal to 80;

The channel width-to-length ratio of MO1, the channel width-to-length ratio of MO2, the channel width-to-length ratio of MO3, and the channel width-to-length ratio of MO4 are all greater than or equal to 100 and less than or equal to 200.

As shown in FIG. 14, the first row of gate line is labeled G1, the second row of gate line is labeled G2, the third row of gate line is labeled G3, the fourth row of gate line is labeled G4, and the fourth row of gate line is labeled G5; the first column of data line is labeled D1, the second column of data line is labeled D2, the third column of data line is labeled D3, and the fourth column of data line is labeled D4;

adjacent rows of gate lines and two adjacent columns of data lines divide a sub-pixel area, and a sub-pixel is arranged in the sub-pixel area;

In FIG. 14, the sub-pixel is labeled PO;

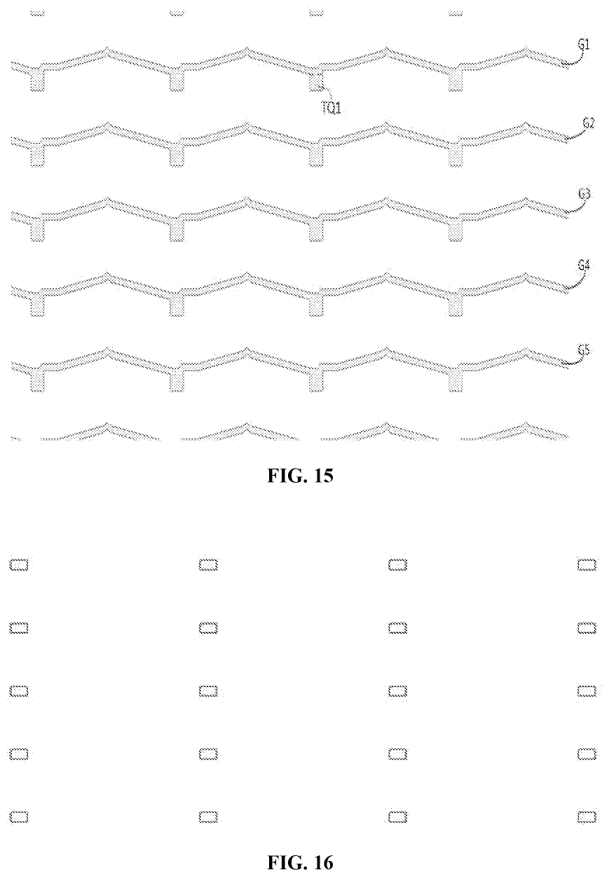

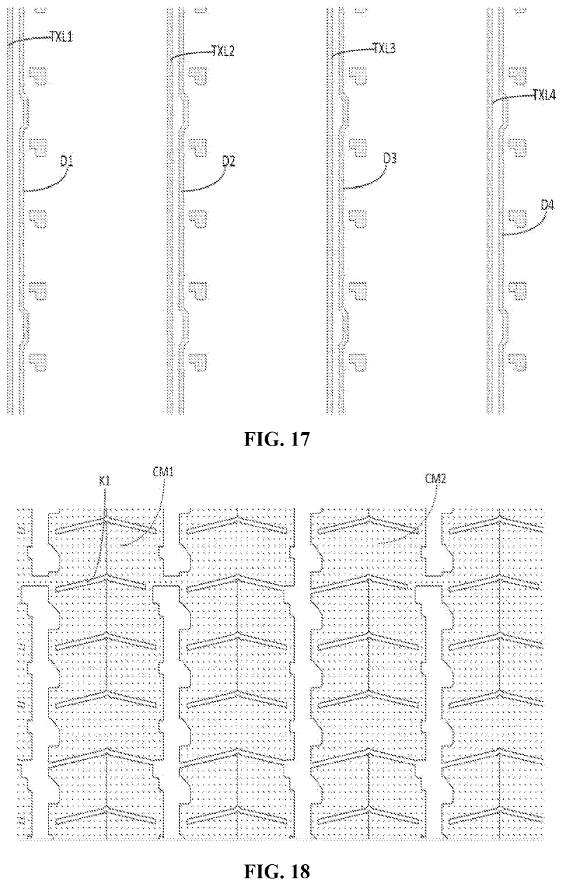

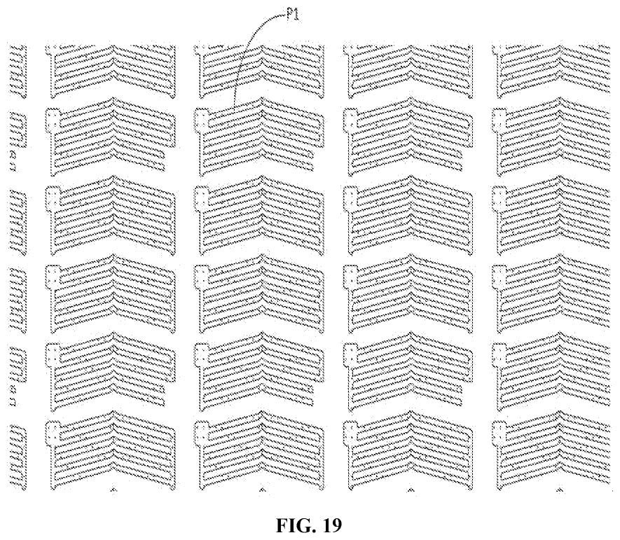

FIG. 15 is a layout diagram of the gate metal layer in FIG. 14, FIG. 16 is a layout diagram of the semiconductor layer in FIG. 14, FIG. 17 is a layout diagram of the source-drain metal layer in FIG. 14, FIG. 18 is a layout diagram of the first conductive layer in FIG. 14, and FIG. 19 is a layout diagram of the second conductive layer in FIG. 14.

In FIG. 15, the first row of gate line is labeled G1, the second row of gate line is labeled G2, the third row of gate line is labeled G3, the third row of gate line is labeled G4, and the fourth row of gate line is labeled G5;

In FIG. 16, each active pattern is an active layer pattern of each switching transistor.

As shown in FIG. 15, each row of gate line has a bent structure;

The first row of gate line G1, the second row of gate line G2, the third row of gate line G3, the fourth row of gate line G4 and the fifth row of gate line are in a bent structure;

In addition, each row of gate line is provided with a protruding block structure for compensation.

In FIG. 15, the first protrusion on the first row of gate line G1 is labeled TQ1.

In FIG. 17, the one labeled D1 is the first column of data line, the one labeled D2 is the second column of the data line, the one labeled D3 is the third column of data line, and the one labeled D4 is the fourth column of data line; the one labeled TXL1 is the first touch signal line, the one labeled TXL2 is the second touch signal line, the one labeled TXL3 is the third touch signal line, and the one labeled TXL4 is the fourth touch signal line.

In FIG. 18, the first common electrode block is labeled CM1, the second common electrode block is labeled CM2, and each common electrode block is multiplexed as a touch signal line.

In FIG. 19, the pixel electrode is labeled P1, and the pixel electrode P1 includes five pixel electrode portions electrically connected to each other, and each pixel electrode portion extends along the second direction.

As shown in FIG. 14, the extension direction of each pixel electrode portion is substantially the same as the extension direction of each gate line, a row of gate line is provided between two adjacent rows of sub-pixels, and a column of data line is provided between two adjacent columns of sub-pixels. At least one embodiment of the present disclosure adopts a pixel structure design of three gate electrodes for TDDI display product, in which the pixel electrodes are placed horizontally, the number of gate lines is three times that of a normal display product, and the number of data lines is one-third of that of a normal display product, thereby greatly reducing the number of data lines while ensuring that the resolution of the display product remains unchanged.

As shown in FIG. 17, in the display area, a first column of data line D1, a first touch signal line TXL1, a second column of data line D2, a second touch signal line TXL2, a third column of data line D3, a third touch signal line TXL3, a fourth column of data line D4 and a fourth touch signal line TXL4 are provided;

D1 and TXL1 are arranged adjacent to each other, D2 and TXL2 are arranged adjacent to each other, D3 and TXL3 are arranged adjacent to each other, D4 and TXL4 are arranged adjacent to each other, and D1, TXL1, D2, TXL2, D3, TXL3, D4 and TXL4 all extend in the vertical direction.

As shown in FIG. 18, a plurality of openings are provided on the first common electrode block CM1, and a plurality of openings are provided on the second common electrode block CM2.

In FIG. 18, K1 is the first opening on CM1.

As shown in FIG. 19, the pixel electrode P1 includes a first pixel electrode portion, a second pixel electrode portion, a third pixel electrode portion, a fourth pixel electrode portion and a fifth pixel electrode portion, which are arranged in sequence from top to bottom and extend in the horizontal direction and are electrically connected to each other; the length of the fourth pixel electrode portion along the horizontal direction and the length of the fifth pixel electrode portion along the horizontal direction are shorter to avoid the bending area of the touch signal line.

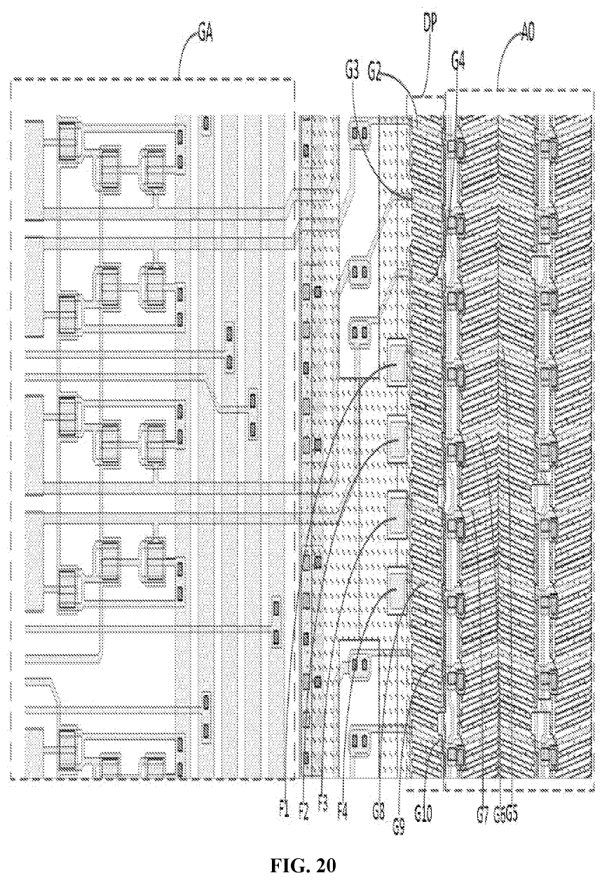

FIG. 20 is a layout diagram of the connection between a GOA (Gate On Array, a gate driving circuit arranged on an array substrate) region and a display region in at least one embodiment of the present disclosure.

In FIG. 20, the area labeled AO is the display area, and the area labeled GA is the GOA area;

The area labeled DP is where the virtual sub-pixels are arranged;

The second row of gate line is labeled G2, the third row of gate line is labeled G3, the fourth row of gate line is labeled G4, the fifth row of gate line is labeled G5, the sixth row of gate line is labeled G6, the seventh row of gate line is labeled G7, the eighth row of gate line is labeled G8, the ninth row of gate line is labeled G9, and the tenth row of gate line is labeled G10;

Each row of gate line includes a left terminal portion and a right terminal portion;

The right terminal of G5, the right terminal of G6, the right terminal of G7 and the right terminal of G8 are signal input terminals, and the driving circuit is electrically connected to the right terminal of G5, the right terminal of G6, the right terminal of G7 and the right terminal of G8, and provides a corresponding driving signal to G5 through the right terminal of G5, provides a corresponding driving signal to G6 through the right terminal of G6, provides a corresponding driving signal to G7 through the right terminal of G7, and provides a corresponding driving signal to G8 through the right terminal of G8;

The display substrate further includes a first electrostatic discharge block F1, a second electrostatic discharge block F2, a third electrostatic discharge block F3 and a fourth electrostatic discharge block F4 arranged on the base substrate;

F1 is electrically connected to the left terminal of G5, F2 is electrically connected to the left terminal of G6, F3 is electrically connected to the left terminal of G7, and F4 is electrically connected to the left terminal of G8;

F1, F2, F3 and F4 can be provided in the same layer and made of a same material as the gate line to release static electricity.

In one embodiment shown in FIG. 20, the left terminal portion of G2, the left terminal portion of G3, the left terminal portion of G4, the left terminal portion of G9, and the left terminal portion of G10 are signal input terminals.

In FIG. 20, a square metal block is added to the left terminal of the fifth row of gate line G5 to the eighth row of gate line G8. The longitudinal width of the metal block is greater than the line width of the gate line. The line width of the gate line is 3.5 μm. The orthographic projection of the metal block on the base substrate is 18 μm. The metal block prevents discharge at the tip terminal of the gate line.

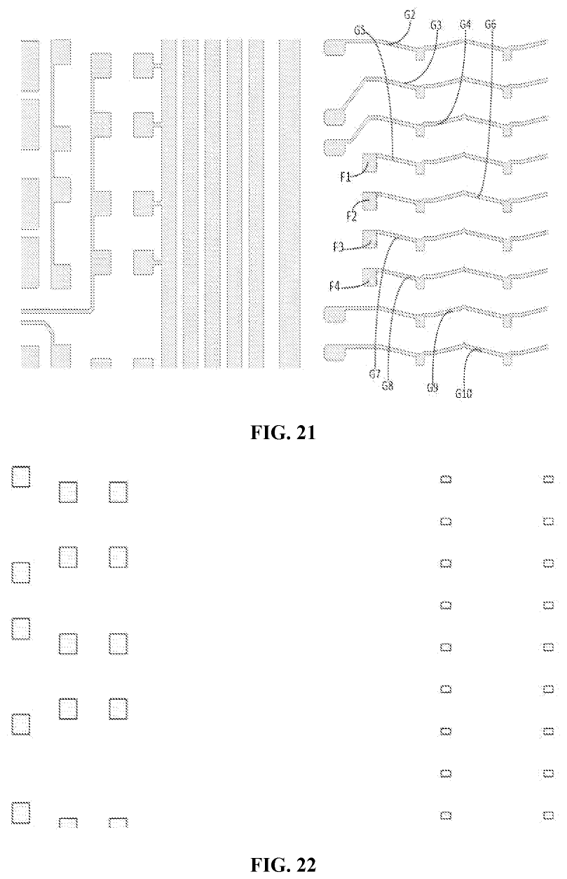

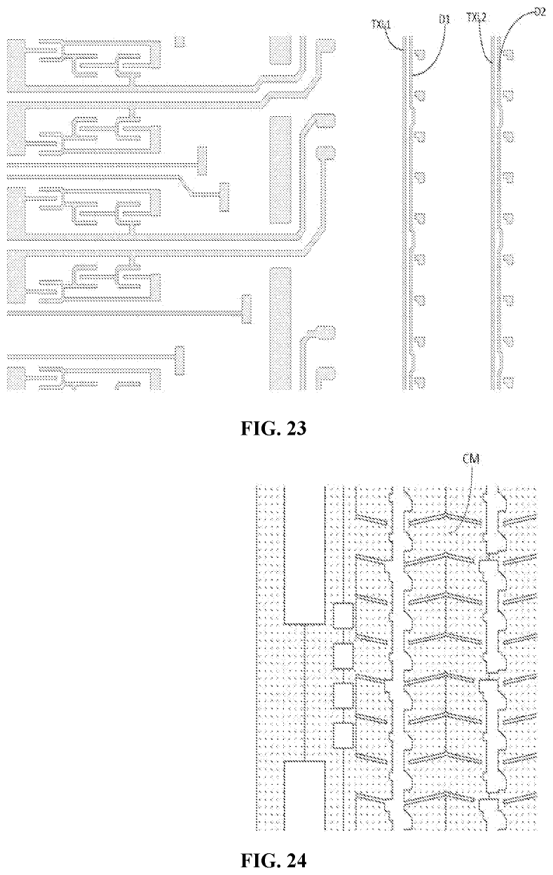

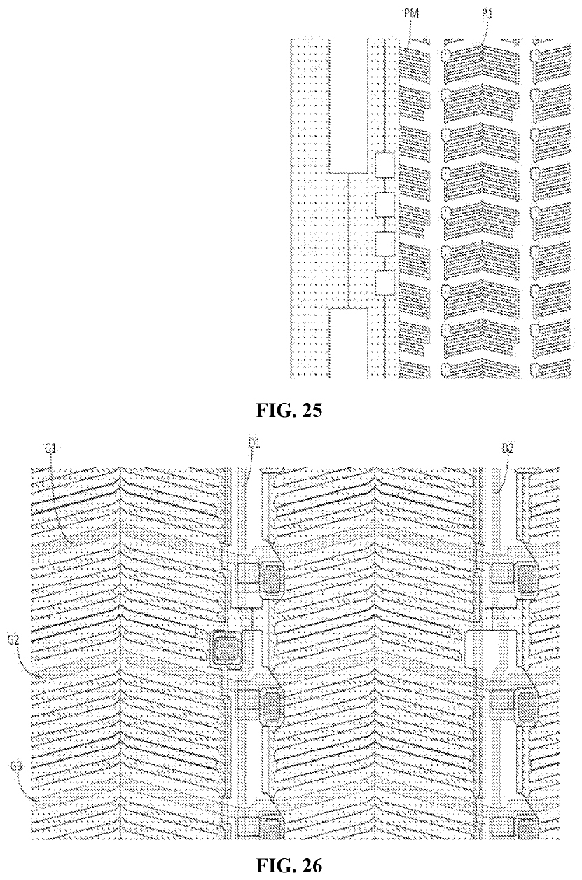

FIG. 21 is a layout diagram of the gate metal layer in FIG. 20, FIG. 22 is a layout diagram of the semiconductor layer in FIG. 20, FIG. 23 is a layout diagram of the source-drain metal layer in FIG. 20, FIG. 24 is a layout diagram of the first conductive layer in FIG. 20, and FIG. 25 is a layout diagram of the second conductive layer in FIG. 20.

In FIG. 23, the line labeled TXL1 is a first touch signal line, the line labeled TXL2 is a second touch signal line, the line labeled D1 is a first column of data line, and the line labeled D2 is a second column of data line.

In FIG. 24, the common electrode block is labeled by CM.

As shown in FIG. 25, the pixel electrode in the virtual sub-pixel is labeled PM, and the pixel electrode in the sub-pixel arranged in the display area A0 is labeled P1;

As can be seen from FIG. 25, the length of the pixel electrode PM in the virtual sub-pixel along the horizontal direction is smaller than the length of the pixel electrode PA in the sub-pixel along the horizontal direction, so as to facilitate the realization of a narrow frame.

FIG. 26 is a layout diagram of a partial area in the display area of the display panel;

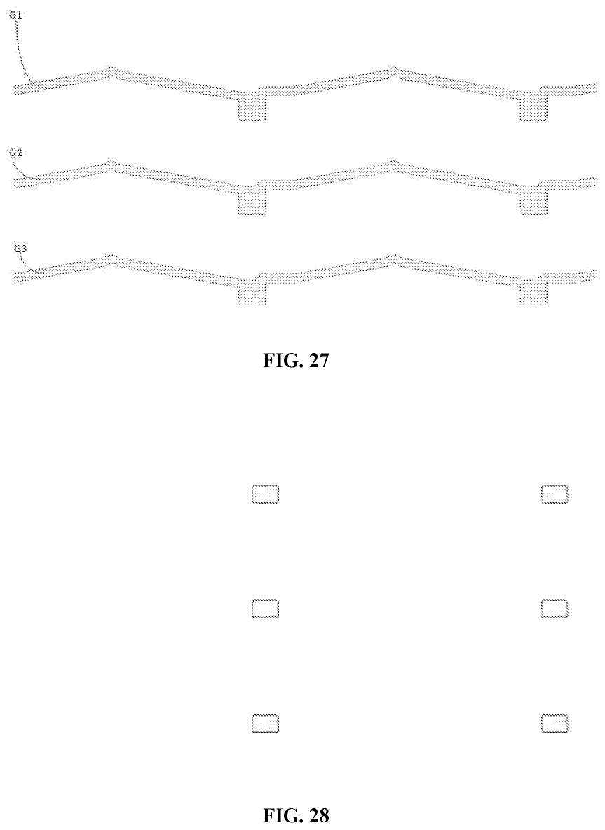

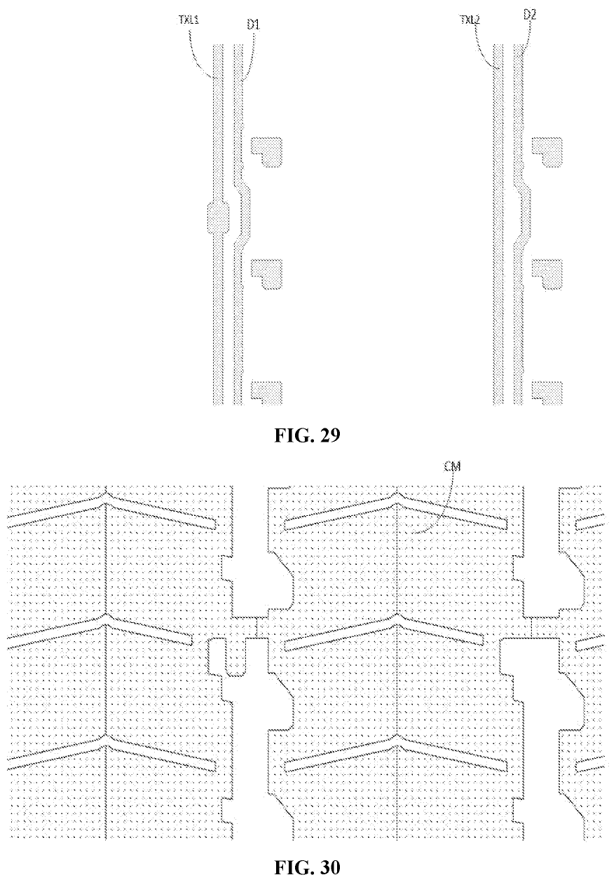

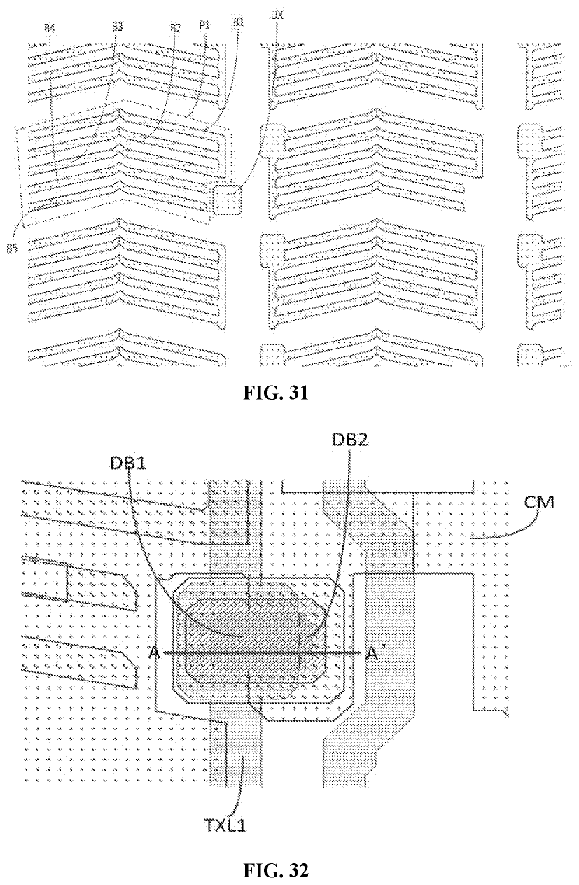

FIG. 27 is a layout diagram of the gate metal layer in FIG. 26, FIG. 28 is a layout diagram of the semiconductor layer in FIG. 26, FIG. 29 is a layout diagram of the source-drain metal layer in FIG. 26, FIG. 30 is a layout diagram of the first conductive layer in FIG. 26, and FIG. 31 is a layout diagram of the second conductive layer in FIG. 26.

In FIG. 26 and FIG. 27, the first row of gate line is labeled G1, the second row of gate line is labeled G2, and the third row of gate line is labeled G3;

In FIG. 29, the line labeled TXL1 is a first touch signal line, the line labeled TXL2 is a second touch signal line, the line labeled D1 is a first data line, and the line labeled D2 is a second data line;

In FIG. 28, each active pattern is an active layer pattern of each switching transistor.

In FIG. 30, the common electrode block is labeled CM, and the common electrode block CM is multiplexed as a touch electrode;

In FIG. 31, the pixel electrode is labeled P1, and the conductive pattern is labeled DX;

The pixel electrode P1 and the conductive pattern DX are arranged in the same layer and made of the same material;

The pixel electrode P1 includes a first pixel electrode portion B1, a second pixel electrode portion B2, a third pixel electrode portion B3, a fourth pixel electrode portion B4 and a fifth pixel electrode portion B5 which are electrically connected to each other;

Each pixel electrode portion extends along a second direction, and the extending direction of each pixel electrode portion is substantially the same as the extending direction of each gate line;

The conductive pattern DX is set on the right side of B4 and B5;

The width of B4 along the horizontal direction is smaller than the width of B1 along the horizontal direction, the width of B4 along the horizontal direction is smaller than the width of B2 along the horizontal direction, the width of B4 along the horizontal direction is smaller than the width of B3 along the horizontal direction, the width of B5 along the horizontal direction is smaller than the width of B1 along the horizontal direction, the width of B5 along the horizontal direction is smaller than the width of B2 along the horizontal direction, and the width of B5 along the horizontal direction is smaller than the width of B3 along the horizontal direction; so that the conductive pattern DX can be arranged in the space on the right side of B4 and B5;

As shown in FIG. 26, the conductive pattern DX is electrically connected to the first touch signal line TXL 1 and the common electrode block CM through the first via hole, so that the first touch signal line TXL1 is electrically connected to the common electrode block CM, so that a touch signal can be provided to the common electrode block CM through the first touch signal line TXL1 during the touch detection time period.

FIG. 32 is an enlarged schematic diagram of the first via hole in FIG. 26.

As shown in FIG. 32, the conductive pattern includes a first conductive pattern portion DB1 and a second conductive pattern portion DB2;

The first conductive pattern portion DB1 is electrically connected to the first touch signal line TXL1 through a first via hole portion arranged on the left side and included in the first via hole;

The first conductive pattern portion DB1 is electrically connected to the first touch signal line TXL1 through the first via hole portion included in the first via hole;

The second conductive pattern portion DB2 is electrically connected to the common electrode block CM through the second via hole portion included in the first via hole;

The orthographic projection of the conductive pattern DX on the base substrate covers the orthographic projection of the first via hole on the base substrate;

The first conductive pattern DB1 is formed on the second conductive layer, the first touch signal line TXL1 is formed on the source-drain metal layer, and the common electrode block CM is formed on the first conductive layer; the source-drain metal layer, the first conductive layer, and the second conductive layer are arranged in sequence in a direction away from the base substrate;

An organic film layer is arranged between the source-drain metal layer and the first conductive layer, and a passivation layer is arranged between the first conductive layer and the second conductive layer.

In one embodiment shown in FIG. 32, the first via hole is a half-lapped hole, and the first via hole portion arranged on the left side penetrates the passivation layer and the organic film layer to reach the first touch signal line TXL1 on the source-drain metal layer.

The second via hole portion arranged on the right side penetrates the organic film layer and reaches the common electrode block CM on the first conductive layer.

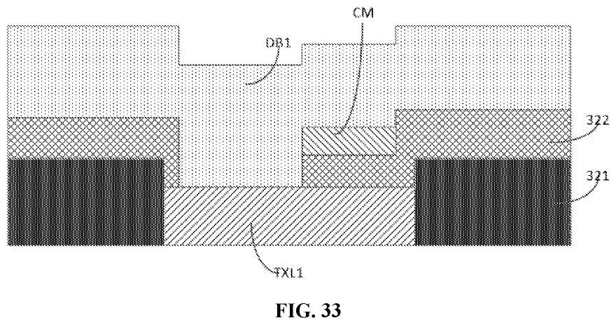

FIG. 33 is a cross-sectional view taken along line AA′ in FIG. 32.

In a specific implementation, 8Mask may be used to manufacture the display substrate described in at least one embodiment of the present disclosure;

A gate metal layer, a semiconductor layer, a gate insulating layer, a source-drain metal layer, a first passivation layer, an organic layer, a first conductive layer, a second passivation layer and a second conductive layer can be manufactured;

The gate metal layer, the semiconductor layer, the gate insulating layer, the source-drain metal layer, the first passivation layer, the organic layer, the first conductive layer, the second passivation layer and the second conductive layer may be arranged in sequence in a direction away from the substrate;

The first passivation layer and the second passivation layer may be manufactured by one-step etching.

The material of the semiconductor layer may include amorphous silicon, polycrystalline silicon, and metal oxide materials. Among them, polycrystalline silicon may include low-temperature polycrystalline silicon LTPS, and the metal oxide may include one or more materials of indium gallium zinc oxide (IGZO), indium gallium tin oxide (IGTO), indium tin zinc oxide (ITZO), indium gallium oxide (IGO), indium gallium zinc tin oxide (IGZTO), and rare earth doped oxide (Ln-OS). The material of the semiconductor layer may be amorphous, partially crystalline, single crystal or polycrystalline, and the film layer may be a single layer or multilayer structure.

The display device described in the embodiment of the present disclosure includes the above-mentioned display substrate.

In a specific implementation, in the display device described in at least one embodiment of the present disclosure, the driving module may use a first driving clock signal CK1, a second driving clock signal CK2, a third driving clock signal CK3, a fourth driving clock signal CK4, a fifth driving clock signal CK5, a sixth driving clock signal CK6, a seventh driving clock signal CK7 and an eighth driving clock signal CK8;

The driving module may be electrically connected to the first output clock signal line HC1, the second output clock signal line HC2, the third output clock signal line HC3, the fourth output clock signal line HC4, the fifth output clock signal line HC5, the sixth output clock signal line HC6, the seventh output clock signal line HC7, the eighth output clock signal line HC8, the ninth output clock signal line HC9, the tenth output clock signal line HC10, the eleventh output clock signal line HC11 and the twelfth output clock signal line HC12;

Each stage of driving circuit can output three stages of driving signals;

The (6n-5)th stage of driving circuit is connected to the first driving control clock signal CK1, the (6n-4)th stage of driving circuit is connected to the second driving control clock signal CK2, the (6n-3)th stage of driving circuit is connected to the third driving control clock signal CK3, the (6n-2)th stage of driving circuit is connected to the fourth driving control clock signal CK4, the (6n-1)th stage of driving circuit is connected to the fifth driving control clock signal CK5, and the 6nth stage of driving circuit is connected to the sixth driving control clock signal CK6; n is a positive integer;

The first stage of driving circuit is electrically connected to HC1, HC2 and HC3 respectively, the second stage of driving circuit is electrically connected to HC4, HC5 and HC6 respectively, the third stage of driving circuit is electrically connected to HC7, HC8 and HC9 respectively, the fourth stage of driving circuit is electrically connected to HC10, HC11 and HC12 respectively, and so on;

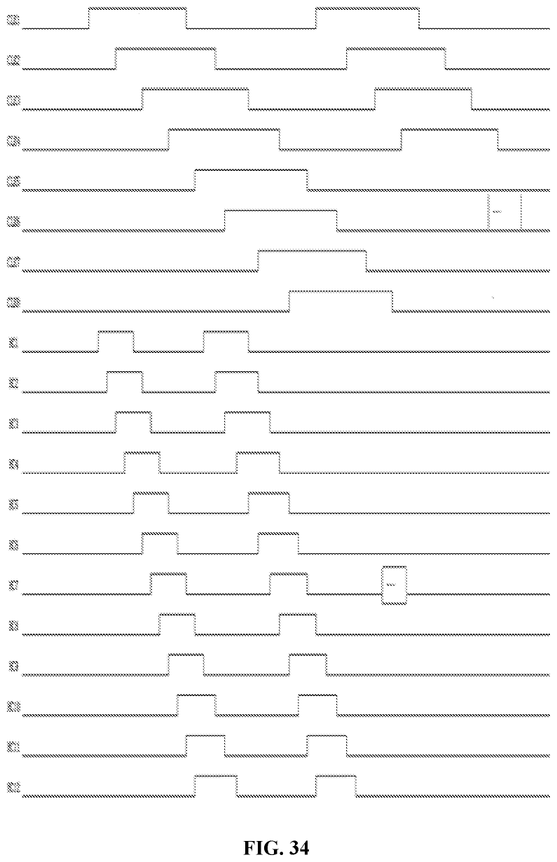

FIG. 34 is a waveform diagram of CK1, CK2, CK3, CK4, CK5, CK6, CK7, CK8, a first output clock signal provided by HC1, a second output clock signal provided by HC2, a third output clock signal provided by HC3, a fourth output clock signal provided by HC4, a fifth output clock signal provided by HC5, a sixth output clock signal provided by HC6, a seventh output clock signal provided by HC7, an eighth output clock signal provided by HC8, a ninth output clock signal provided by HC9, a tenth output clock signal provided by HC10, an eleventh output clock signal provided by HC11, and a twelfth output clock signal provided by HC12;

The odd-numbered stages of driving circuits may be arranged on the left side of the display area, and the even-numbered stages of driving circuits may be arranged on the right side of the display area.

In a specific implementation, in the display device described in at least one embodiment of the present disclosure, the driving module may use a first driving clock signal CK1, a second driving clock signal CK2, a third driving clock signal CK3, a fourth driving clock signal CK4, a fifth driving clock signal CK5 and a sixth driving clock signal CK6;

The driving module may be electrically connected to the first output clock signal line HC1, the second output clock signal line HC2, the third output clock signal line HC3, the fourth output clock signal line HC4, the fifth output clock signal line HC5, the sixth output clock signal line HC6, the seventh output clock signal line HC7, the eighth output clock signal line HC8, the ninth output clock signal line HC9, the tenth output clock signal line HC10, the eleventh output clock signal line HC11 and the twelfth output clock signal line HC12;

Each stage of driving circuit can output four stages of driving signals;

The first stage of driving circuit is electrically connected to HC1, HC2, HC3 and HC4 respectively, the second stage of driving circuit is electrically connected to HC5, HC6, HC7 and HC8 respectively, and the third stage of driving circuit is electrically connected to HC9, HC10, HC11 and HC12 respectively;

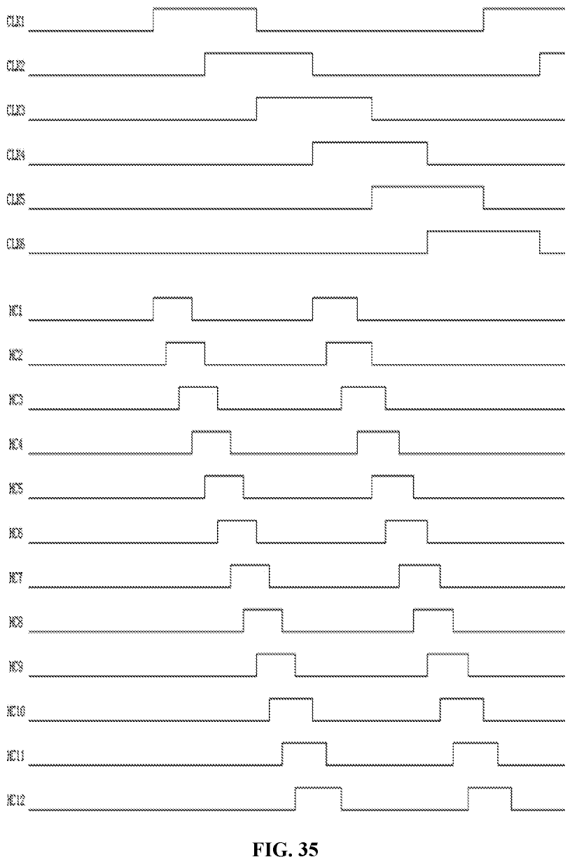

FIG. 35 is CK1, CK2, CK3, CK4, CK5, CK6, HC1 provided a first output clock signal, a second output clock signal provided by HC2, a third output clock signal provided by HC3, a fourth output clock signal provided by HC4, a fifth output clock signal provided by HC5, a sixth output clock signal provided by HC6, a seventh output clock signal provided by HC7, an eighth output clock signal provided by HC8, a ninth output clock signal provided by HC9, a tenth output clock signal provided by HC10, and an eleventh output clock signal provided by HC11.

The above descriptions are implementations of the present disclosure. It should be pointed out that those skilled in the art can make some improvements and modifications without departing from the principle of the present disclosure. These improvements and modifications shall also fall within the scope of the present disclosure.

1. A driving circuit, comprising a driving control signal generation circuit and a multi-channel output circuit; wherein the multi-channel output circuit includes N stages of output sub-circuits; N is an integer greater than 1;
the driving control signal generation circuit is configured to generate a driving control signal, and the driving control signal is output through a driving control signal output terminal;
an nth output sub-circuit is electrically connected to the driving control signal output terminal, a control voltage line, an nth control node, an nth output clock signal line and an nth driving signal output terminal respectively, the nth output sub-circuit is configured to control a potential of the nth control node according to the driving control signal under the control of a control voltage provided by the control voltage line, and to control the nth output clock signal line to provide the nth output clock signal to the nth driving signal output terminal under the control of the potential of the nth control node; n is a positive integer less than or equal to N.

2. The driving circuit according to claim 1, wherein the nth output sub-circuit includes an nth control unit and an nth output unit;
the nth control unit is electrically connected to the driving control signal output terminal, the control voltage line and the nth control node respectively, and is configured to control the potential of the nth control node according to the driving control signal under the control of the control voltage;
the nth output unit is electrically connected to the nth control node, the nth output clock signal line and the nth driving signal output terminal, respectively, and is configured to control the nth output clock signal line to provide the nth output clock signal to the nth driving signal output terminal under the control of the potential of the nth control node.

3. The driving circuit according to claim 2, wherein the nth control unit includes an nth first control transistor; a gate electrode of the nth first control transistor is electrically connected to the control voltage line, a first electrode of the nth first control transistor is electrically connected to the driving control signal output terminal, and a second electrode of the nth first control transistor is electrically connected to the nth control node; or,
the control voltage line includes a first control voltage line and a second control voltage line, and the nth control unit includes an nth first control transistor and an nth second control transistor; a gate electrode of the nth first control transistor is electrically connected to the first control voltage line, a first electrode of the nth first control transistor is electrically connected to the driving control signal output terminal, and a second electrode of the nth first control transistor is electrically connected to the nth control node; a gate electrode of the nth second control transistor is electrically connected to the second control voltage line, a first electrode of the nth second control transistor is electrically connected to the driving control signal output terminal, and a second electrode of the nth second control transistor is electrically connected to the nth control node.

4. The driving circuit according to claim 2, wherein the nth output unit comprises an nth output transistor;
a gate electrode of the nth output transistor is electrically connected to the nth control node, a first electrode of the nth output transistor is electrically connected to the nth output clock signal line, and a second electrode of the nth output transistor is electrically connected to the nth driving signal output terminal.

5. The driving circuit according to claim 2, wherein the nth output sub-circuit further comprises an nth shutdown reset unit;
the nth shutdown reset unit is electrically connected to the first voltage line and the nth driving signal output terminal respectively, and is configured to control the connection or disconnection between the nth driving signal output terminal and the first voltage line under the control of the first voltage signal provided by the first voltage line.

6. The driving circuit according to claim 5, wherein the nth shutdown reset unit comprises an nth shutdown reset transistor;
a gate electrode and a second electrode of the nth shutdown reset transistor are both electrically connected to the first voltage line, and a first electrode of the nth shutdown reset transistor is electrically connected to the nth driving signal output terminal.

7. The driving circuit according to claim 2, wherein the nth output sub-circuit further comprises an nth output capacitor;
a first terminal of the nth output capacitor is electrically connected to the nth control node, and a second terminal of the nth output capacitor is electrically connected to the nth driving signal output terminal.

8. The driving circuit according to claim 1, wherein the nth output sub-circuit further comprises an nth output pull-down unit;
the nth output pull-down unit is electrically connected to the pull-down node, the nth driving signal output terminal and the first voltage line respectively, and is configured to control the connection or disconnection between the nth driving signal output terminal and the first voltage line under the control of the potential of the pull-down node;
wherein the nth output pull-down unit includes an nth first output pull-down transistor; a gate electrode of the nth first output pull-down transistor is electrically connected to the pull-down node, a first electrode of the nth first output pull-down transistor is electrically connected to the nth driving signal output terminal, and a second electrode of the nth first output pull-down transistor is electrically connected to the first voltage line; or,
the pull-down node includes a first pull-down node and a second pull-down node; the nth output pull-down unit includes an nth first output pull-down transistor and an nth second output pull-down transistor; a gate electrode of the nth first output pull-down transistor is electrically connected to the first pull-down node, a first electrode of the nth first output pull-down transistor is electrically connected to the nth driving signal output terminal, and a second electrode of the nth first output pull-down transistor is electrically connected to the first voltage line; a gate electrode of the nth second output pull-down transistor is electrically connected to the second pull-down node, a first electrode of the nth second output pull-down transistor is electrically connected to the nth driving signal output terminal, and a second electrode of the nth second output pull-down transistor is electrically connected to the first voltage line.

9. (canceled)

10. The driving circuit according to claim 1, wherein the pull-down node includes a first pull-down node and a second pull-down node; the driving control signal generation circuit includes a pull-up node control circuit, a first pull-down node control circuit, a second pull-down node control circuit and a driving control output circuit;
the pull-up node control circuit is configured to control a potential of the pull-up node;
the first pull-down node control circuit is configured to control a potential of the first pull-down node under the control of the potential of the pull-up node;
the second pull-down node control circuit is configured to control a potential of the second pull-down node under the control of the potential of the pull-up node;
the driving control output circuit is electrically connected to the pull-up node, the first pull-down node, the second pull-down node, the driving control signal output terminal, the driving control clock signal line and the first voltage line, respectively, and is configured to control the driving control clock signal line to be electrically connected to the driving control signal output terminal under the control of the potential of the pull-up node, control the driving control signal output terminal to be connected to the first voltage line under the control of the potential of the first pull-down node, and control the driving control signal output terminal to be connected to the first voltage line under the control of the potential of the second pull-down node.

11. The driving circuit according to claim 10, wherein the driving control signal generation circuit further comprises a carry output circuit;
the carry output circuit is electrically connected to the pull-up node, the first pull-down node, the second pull-down node, the carry output terminal, the driving control clock signal line and the second voltage line, respectively, and is configured to control the driving control clock signal line to be electrically connected to the carry output terminal under the control of the potential of the pull-up node, control the carry output terminal to be connected to the second voltage line under the control of the potential of the first pull-down node, and control the carry output terminal to be connected to the second voltage line under the control of the potential of the second pull-down node.

12. The driving circuit according to claim 11, wherein the pull-up node control circuit is electrically connected to an input terminal, a frame reset line, the first pull-down node, the second pull-down node, the first reset terminal, the pull-up node, and the second voltage line, respectively, and is configured to control the potential of the pull-up node under the control of the input signal provided by the input terminal, and control the connection between the pull-up node and the second voltage line under the control of the frame reset signal provided by the frame reset line, control the connection between the pull-up node and the second voltage line under the control of the potential of the first pull-down node, control the connection between the pull-up node and the second voltage line under the control of the potential of the second pull-down node, and control the connection between the pull-up node and the second voltage line under the control of the first reset signal provided by the first reset terminal;
the first pull-down node control circuit is electrically connected to the first control voltage line, the first pull-down node, the pull-up node and the second voltage line respectively, and is configured to control the potential of the first pull-down node under the control of the first control voltage provided by the first control voltage line and the potential of the pull-up node;
the second pull-down node control circuit is electrically connected to the second control voltage line, the second pull-down node, the pull-up node and the second voltage line respectively, and is configured to control the potential of the second pull-down node under the control of the second control voltage provided by the second control voltage line and the potential of the pull-up node;
the driving control output circuit is also electrically connected to a second reset terminal, and is configured to control the connection between the driving control signal output terminal and the first voltage line under the control of a second reset signal provided by the second reset terminal.

13. The driving circuit according to claim 12, wherein the pull-up node control circuit includes a first transistor, a second transistor, a third transistor, a fourth transistor and a fifth transistor;
a gate electrode of the first transistor and a first electrode of the first transistor are electrically connected to the input terminal, and a second electrode of the first transistor is electrically connected to the pull-up node;
a gate electrode of the second transistor is electrically connected to the first reset terminal, a first electrode of the second transistor is electrically connected to the pull-up node, and a second electrode of the second transistor is electrically connected to the second voltage line;
a gate electrode of the third transistor is electrically connected to the frame reset line, a first electrode of the third transistor is electrically connected to the pull-up node, and a second electrode of the third transistor is electrically connected to the second voltage line;
a gate electrode of the fourth transistor is electrically connected to the first pull-down node, a first electrode of the fourth transistor is electrically connected to the pull-up node, and a second electrode of the fourth transistor is electrically connected to the second voltage line;
a gate electrode of the fifth transistor is electrically connected to the second pull-down node, a first electrode of the fifth transistor is electrically connected to the pull-up node, and a second electrode of the fifth transistor is electrically connected to the second voltage line;
the first pull-down node control circuit includes a sixth transistor and a seventh transistor;
a gate electrode of the sixth transistor and a first electrode of the sixth transistor are electrically connected to the first control voltage line, and a second electrode of the sixth transistor is electrically connected to the first pull-down node;
a gate electrode of the seventh transistor is electrically connected to the pull-up node, a first electrode of the seventh transistor is electrically connected to the first pull-down node, and a second electrode of the seventh transistor is electrically connected to the second voltage line;
the second pull-down node control circuit includes an eighth transistor and a ninth transistor;
a gate electrode of the eighth transistor and a first electrode of the eighth transistor are electrically connected to the second control voltage line, and a second electrode of the eighth transistor is electrically connected to the second pull-down node;
a gate electrode of the ninth transistor is electrically connected to the pull-up node, a first electrode of the ninth transistor is electrically connected to the second pull-down node, and a second electrode of the ninth transistor is electrically connected to the second voltage line;
or
wherein the first pull-down node control circuit further includes a tenth transistor, and the second pull-down node control circuit further includes an eleventh transistor;
a gate electrode of the tenth transistor is electrically connected to the input terminal. a first electrode of the tenth transistor is electrically connected to the first pull-down node, and a second electrode of the tenth transistor is electrically connected to the second voltage line;
a gate electrode of the eleventh transistor is electrically connected to the input terminal, a first electrode of the eleventh transistor is electrically connected to the second pull-down node, and a second electrode of the eleventh transistor is electrically connected to the second voltage line;
the carry output circuit includes a twelfth transistor, a thirteenth transistor and a fourteenth transistor;
a gate electrode of the twelfth transistor is electrically connected to the pull-up node, a first electrode of the twelfth transistor is electrically connected to the driving control clock signal line, and a second electrode of the twelfth transistor is electrically connected to the carry output terminal;
a gate electrode of the thirteenth transistor is electrically connected to the first pull-down node, a first electrode of the thirteenth transistor is electrically connected to the carry output terminal, and a second electrode of the thirteenth transistor is electrically connected to the second voltage line;
a gate electrode of the fourteenth transistor is electrically connected to the second pull-down node, a first electrode of the fourteenth transistor is electrically connected to the carry output terminal, and a second electrode of the fourteenth transistor is electrically connected to the second voltage line;
the driving control output circuit includes a fifteenth transistor, a sixteenth transistor, a seventeenth transistor, an eighteenth transistor and a first capacitor;
a gate electrode of the fifteenth transistor is electrically connected to the pull-up node, a first electrode of the fifteenth transistor is electrically connected to the driving control clock signal line, and a second electrode of the fifteenth transistor is electrically connected to the driving control signal output terminal;
a gate electrode of the sixteenth transistor is electrically connected to the first pull-down node, a first electrode of the sixteenth transistor is electrically connected to the driving control signal output terminal, and a second electrode of the sixteenth transistor is electrically connected to the first voltage line;
a gate electrode of the seventeenth transistor is electrically connected to the second pull-down node, a first electrode of the seventeenth transistor is electrically connected to the driving control signal output terminal, and a second electrode of the seventeenth transistor is electrically connected to the first voltage line;
a gate electrode of the eighteenth transistor is electrically connected to the second reset terminal, a first electrode of the eighteenth transistor is electrically connected to the driving control signal output terminal, and a second electrode of the eighteenth transistor is electrically connected to the first voltage line;
a first electrode plate of the first capacitor is electrically connected to the pull-up node, and a second electrode plate of the first capacitor is electrically connected to the driving control signal output terminal.

14. (canceled)

15. A display substrate, comprising a base substrate and a plurality of driving circuits according to claim 1 arranged on the base substrate.

16. The display substrate according to claim 15, wherein the display substrate comprises a peripheral area and a display area; the driving circuit includes the driving control signal generation circuit and the multi-channel output circuit;
the multi-channel output circuit and the driving control signal generation circuit are arranged in the peripheral area;
the multi-channel output circuit is arranged on a side of the driving control signal generation circuit close to the display area.

17. The display substrate according to claim 16, wherein the multi-channel output circuit includes N output sub-circuits and N output clock signal lines; N is an integer greater than 1;
the output clock signal line is arranged on a side of the output sub-circuit close to the display area, and the output clock signal line extends along a first direction.

18. The display substrate according to claim 17, wherein the nth output sub-circuit includes an nth control unit and an nth output unit; n is a positive integer less than or equal to N;
the nth control unit is arranged on a side of the nth output unit away from the display area.

19. The display substrate according to claim 17, wherein an active pattern of a transistor included in the nth control unit includes at least one active portion independent of each other, and an active pattern of a transistor included in the nth output unit includes at least one active portion independent of each other.

20. The display substrate according to claim 18, wherein the nth output sub-circuit includes an nth shutdown reset unit, an nth output capacitor and an nth output pull-down unit;
the nth output pull-down unit is arranged between the nth shutdown reset unit and the nth output capacitor;
the nth output capacitor is arranged between the nth output unit and the nth output pull-down unit;
output capacitors respectively included in the N output sub-circuits are arranged along the first direction;
active layer patterns of transistors in the shutdown reset units included in the N output sub-circuits are arranged along the first direction;
active layer patterns of transistors in output pull-down units included in the N output sub-circuits are arranged along the first direction.

21. The display substrate according to claim 16, further comprising a driving control clock signal line, a frame reset line, a first voltage line, a second voltage line, a first control voltage line, and a second control voltage line; wherein
the driving control clock signal line, the frame reset line, the first voltage line, the second voltage line, the first control voltage line and the second control voltage line are arranged on a side of the driving control signal generation circuit away from the display area.

22.-33. (canceled)

34. A display device comprising the display substrate according to claim 15.
